(19) United States
(12) Patent Application Publication
(10) Pub. No.: US 2026/0287370 A1
(43) Pub. Date: Sep. 24, 2026

(54) SYSTEM

(71) Applicant: SoftBank Group Corp., Tokyo (JP)

(72) Inventor: Takaharu ISHIKAWA, Tokyo (JP)

(73) Assignee: SoftBank Group Corp., Tokyo (JP)

(21) Appl. No.: 19/568,790

(22) Filed: Mar. 17, 2026

(30) Foreign Application Priority Data
Mar. 19, 2025 (JP) 2025-045104

(51) Int. Cl. G01C 21/34; G06F 40/40; G06N 3/0475

(52) U.S. Cl. CPC G01C 21/3415; G01C 21/3461; G01C 21/3492; G06N 3/0475; G06F 40/40

(57) ABSTRACT

A system includes a processor that is configured to acquire a current location of a user by using a GPS sensor, download required map information from a map database via the Internet, and generate a prompt for instructing a generative AI model to calculate an optimal route and input the prompt to the generative AI model.

### CROSS-REFERENCE TO RELATED APPLICATION

This application is based on and claims priority under 35 USC 119 from Japanese Patent Application No. 2025-045104 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional navigation and route guidance systems typically rely on fixed algorithms and pre-defined rule sets to calculate routes based on static map data and simple parameters such as distance or estimated travel time. Such systems are not well-suited to flexibly incorporate diverse and dynamically changing information, including user-specific contexts, complex environmental conditions, and real-time sensor inputs. As a result, it is difficult to provide routes that are globally optimal in view of safety, efficiency, and contextual relevance. Furthermore, existing systems generally do not effectively utilize generative AI models, which are capable of handling natural language prompts and generating sophisticated outputs based on large-scale training data, to compute optimal routes or evacuation routes in response to rapidly changing obstacles and weather conditions. Consequently, there is a need for a system that can: (i) automatically obtain a user's current location and corresponding map information, (ii) generate appropriate prompts for instructing a generative AI model to calculate an optimal route, (iii) deliver the resulting route to a user terminal in real time, and (iv) analyze sensor data to dynamically determine evacuation behavior and generate safe evacuation routes under hazardous circumstances.

### SUMMARY

In order to solve the above-described problems, an embodiment of the present invention provides a system comprising a processor. The processor is configured to acquire a current location of a user by using a GPS sensor, download required map information from a map database via the Internet, and generate a prompt for instructing a generative AI model to calculate an optimal route and input the prompt to the generative AI model. By generating the prompt based on the current location and the downloaded map information, the processor enables the generative AI model to compute an optimal route that can flexibly take into account various factors beyond simple distance or time. In addition, the processor is configured to transmit route information calculated by the generative AI model to a terminal of the user by using a wireless communication technology, thereby allowing the user to receive up-to-date route guidance on a mobile device or other terminal. Furthermore, the processor is configured to analyze data from one or more sensors, determine evacuation based on at least one of an obstacle and a weather condition, and generate a safe evacuation route. Through analysis of real-time sensor data and environmental conditions, the system can dynamically switch from normal route guidance to evacuation guidance, and can provide a safe evacuation route generated with the assistance of the generative AI model, thereby improving safety and reliability in environments subject to obstacles and adverse weather.

The term “system” refers to an integrated arrangement of hardware and software components including at least one processor, memory, communication interfaces, and optionally sensors and user terminals, which cooperatively perform the functions described in the claims.

The term “processor” refers to any hardware component or combination of components that executes instructions, including but not limited to a central processing unit (CPU), a microcontroller, a digital signal processor (DSP), a graphics processing unit (GPU), or a plurality of such units operating together.

The term “GPS sensor” refers to a hardware module configured to receive signals from a Global Positioning System or compatible satellite positioning system and to output position information including at least latitude and longitude corresponding to a current location.

The term “current location of a user” refers to geographic position information that is associated with a user, including at least latitude and longitude, which is obtained directly from a GPS sensor carried by the user or indirectly from a device associated with the user. The term “map database” refers to a data storage resource that stores digital map information, including but not limited to road networks, geographic coordinates, points of interest, and other spatial data used for route calculation.

The term “map information” refers to data retrieved from the map database, including at least geographic coordinates, road segments, and connections, and optionally additional attributes such as speed limits, restrictions, or environmental annotations, which are used to support route computation.

The term “download” refers to the operation in which data, such as map information, is transferred from a remote server or map database to the system via a communication network, including the Internet.

The term “Internet” refers to a global communication network consisting of interconnected networks and infrastructure that enables data exchange using standardized communication protocols.

The term “generative AI model” refers to a machine learning model, such as a large language model or other generative model, trained on large-scale data and configured to generate outputs including text or structured data in response to input prompts.

The term “prompt” refers to data, typically represented as text or structured input, that is provided to a generative AI model to instruct the model to perform a particular computation, such as calculating an optimal route, and to condition the content of the model's output.

The term “optimal route” refers to a path between a starting point and a destination that is determined to be preferable according to one or more criteria, including but not limited to shortest distance, shortest estimated travel time, safety, or a weighted combination of such criteria.

The term “route information” refers to data representing an optimal route, including at least a sequence of geographic positions or waypoints, and optionally additional attributes such as recommended speed, segment distances, or estimated times.

The term “wireless communication technology” refers to any technology that enables data transmission without a wired physical connection, including but not limited to cellular communication, Wi-Fi, Bluetooth, or other radio-based communication methods.

The term “terminal of the user” refers to an electronic device associated with a user, such as a smartphone, tablet, wearable device, or in-vehicle system, which is capable of receiving route information via wireless communication and presenting the information to the user.

The term “sensor” refers to a hardware device that measures or detects a physical quantity or environmental condition, including but not limited to distance sensors, cameras, lidar, radar, accelerometers, gyroscopes, temperature sensors, and weather sensors.

The term “data from one or more sensors” refers to measurement values or signals output by one or more sensors, including raw data or preprocessed data, which describe conditions in the environment or the state of a device.

The term “obstacle” refers to a physical object or condition, such as a building, vehicle, structure, terrain feature, or other obstruction, that interferes with or increases risk along a route or at a current location.

The term “weather condition” refers to meteorological circumstances including, but not limited to, wind, rain, snow, fog, temperature, and storms, which may influence route safety or feasibility.

The term “evacuation” refers to a change in movement or route from a current path to a safer path or location in response to an obstacle or a weather condition that is determined to be hazardous.

The term “safe evacuation route” refers to a route that is generated in view of safety criteria to guide movement from a current location to a destination considered safer, while avoiding or reducing exposure to identified obstacles or adverse weather conditions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

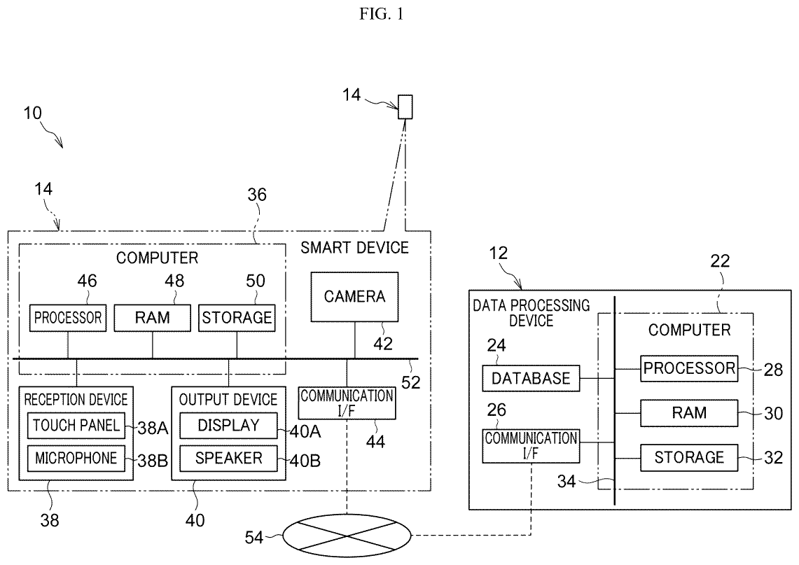

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

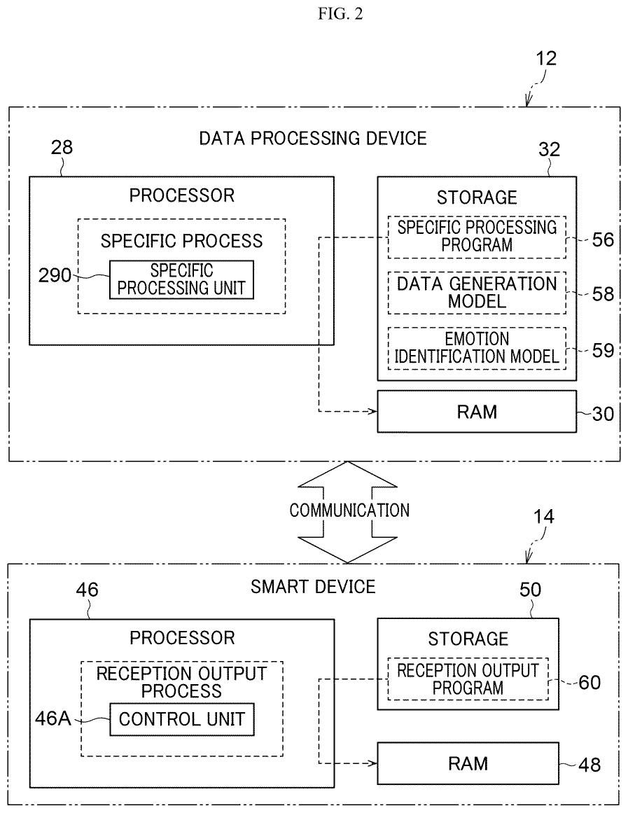

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional route planning technologies for mobile bodies, such as aerial vehicles and ground vehicles, generally rely on deterministic algorithms that operate on static map data and simple sensor inputs. These systems are typically implemented as fixed heuristic or graph-search procedures that do not flexibly incorporate heterogeneous, time-varying context information, such as dynamic obstacles, changing weather, user-specific constraints, and evolving operational rules. As a result, the systems often exhibit degraded performance in terms of safety, efficiency, and robustness when deployed in complex real-world environments.

Furthermore, existing systems that attempt to use machine learning models for route planning tend to treat the models as black-box predictors and do not provide a systematic, computer-implemented mechanism for constructing input representations to the models in a manner that is dynamically aligned with the current operational context. In particular, there is no integrated framework in which a processor: (i) continuously acquires sensor data and map data; (ii) transforms the acquired data and user-supplied constraints into a structured prompt sentence; (iii) inputs the prompt sentence into a generative AI model; and (iv) post-processes the model output to enforce safety and feasibility in real time. In the absence of such mechanisms, the computing resources of the generative AI model are not effectively utilized, and the overall computing system may produce route proposals that are either sub-optimal or require extensive manual oversight.

Additionally, known route planning architectures generally lack a feedback loop that uses live telemetry from the mobile body to drive iterative re-prompting and dynamic re-generation of route information by a generative AI model. Telemetry data, such as real-time position information and state information (for example, battery level, flight anomalies, or communication quality), is often logged or used for simple threshold checks, but is not coherently integrated into a multi-stage computation that re-formulates the prompt given to the generative AI model. Consequently, the computing system is unable to efficiently adapt the planned route when deviations, hazards, or new constraints arise during operation, leading to increased computational waste, delayed responses, and a higher probability of mission failure.

Moreover, existing systems do not provide a computer-implemented mechanism for translating natural language instructions from a user into machine-processable prompt sentences that consistently encode safety rules, regulatory constraints, and context-dependent preferences. Natural language interfaces, where present, are usually thin layers on top of manually designed routing engines, and they do not fundamentally alter the underlying data flow and compute flow of the route planning pipeline. This results in a gap between user-level intent and system-level control logic, and prevents the computing system from automatically reconciling user-specified constraints with real-time environmental data. There is therefore a need for an improved computer-implemented route planning system that integrates: (i) structured acquisition and fusion of position information, map information, obstacle information, and weather information; (ii) automatic generation of prompt sentences tailored to a generative AI model; (iii) safety and feasibility validation of generated route points; (iv) dynamic updating of route information based on telemetry feedback; and (v) programmatic handling of user natural language instructions. Such a system should improve the functioning of the underlying computer technology by structuring data flows and compute flows so that the generative AI model is invoked with context-aware prompts and its outputs are constrained and refined by additional algorithmic processing, thereby enhancing overall safety, efficiency, and responsiveness of the route planning computation.

The specific processing by the specific processing unit 290 of the data processing device 12 in Example 1 is realized by the following means.

The present invention provides a server comprising a processor and a memory storing instructions which, when executed by the processor, cause the processor to acquire position information indicating a current position of a mobile body from a position detection device, to acquire map information including road information, obstacle information, and traffic information from a geographic information storage device via a communication network, to generate environment state data by integrating the position information and the map information based on destination information and constraint condition information received from a user terminal, to generate a prompt sentence for input to a generative AI model based on the environment state data, to input the prompt sentence to the generative AI model and thereby cause the generative AI model to generate route information including a plurality of route points and a recommended movement condition corresponding to each of the route points for movement of the mobile body to a destination, to verify safety and feasibility of each of the route points included in the route information based on the map information and no-go-zone information and to correct the route information, to calculate an estimated arrival time of the mobile body based on the corrected route information, to transmit the corrected route information and the estimated arrival time to the mobile body and the user terminal, to acquire position information and state information periodically transmitted from the mobile body, to calculate a deviation between the acquired information and the corrected route information, and to generate, based on the deviation, a further prompt sentence for re-input to the generative AI model so as to dynamically update the route information. This enables the underlying computer system to perform route planning and re-planning as a closed-loop computational process in which heterogeneous sensor data, map data, and user constraints are transformed into structured prompt sentences, processed by a generative AI model, and post-processed by safety-aware algorithms, thereby improving the safety, adaptability, and computational efficiency of route generation and execution compared with conventional static or heuristic-based routing techniques.

The term “processor” refers to one or more hardware processing units, such as a central processing unit or a graphics processing unit, that are configured to execute instructions stored in a memory to perform functions of the system.

The term “memory” refers to a non-transitory computer-readable storage medium that stores instructions and data for execution and use by the processor.

The term “mobile body” refers to any movable apparatus, including an aerial vehicle, a ground vehicle, or a robotic platform, whose movement along a route is controlled based on route information generated by the system.

The term “position detection device” refers to any hardware component or combination of components, such as a satellite positioning sensor or an inertial sensor, that is configured to output data indicative of a current position of the mobile body.

The term “position information” refers to data representing a geographical location of the mobile body, including at least one of latitude, longitude, altitude, and a timestamp.

The term “geographic information storage device” refers to any server or storage apparatus that stores geographic data, including road information, obstacle information, traffic information, and area attributes, and that is accessible via a communication network.

The term “map information” refers to digital geographic data obtained from the geographic information storage device, including at least one of road information, obstacle information, traffic information, region boundaries, and elevation information.

The term “road information” refers to data representing paths or routes on a surface, such as roads, streets, or lanes, including attributes such as connectivity, direction, and permitted movement conditions.

The term “obstacle information” refers to data representing static or dynamic objects or regions that restrict or influence movement of the mobile body, such as buildings, terrain features, no-fly zones, or detected physical objects.

The term “traffic information” refers to data indicating a state of movement or congestion in an area, including at least one of traffic density, average speed, or flow restrictions affecting possible routes.

The term “communication network” refers to any wired or wireless data communication infrastructure, such as the internet or a cellular network, through which the server exchanges data with external devices and services.

The term “user terminal” refers to any computing device operated by a user, such as a mobile device, a tablet, or a personal computer, that is configured to transmit destination information and constraint condition information to the server and to receive route information and related notifications.

The term “destination information” refers to data specifying a target location for the mobile body, including at least one of an address, a landmark name, coordinates, or a location identifier.

The term “constraint condition information” refers to data representing preferences, limitations, or rules for route generation, such as safety margins, altitude ranges, avoidance regions, or user-specified priorities.

The term “environment state data” refers to a data structure generated by integrating position information, map information, destination information, and constraint condition information, and representing a current operational context for route planning.

The term “generative AI model” refers to a machine-implemented model, such as a neural network, trained to generate structured outputs, including route information, based on input data, including prompt sentences that describe an operational context.

The term “prompt sentence” refers to a machine-processable textual representation that encodes environment state data, constraints, and objectives, and that is provided as input to the generative AI model to cause the generative AI model to generate route information.

The term “route information” refers to data generated by the generative AI model and processed by the system, including a plurality of route points and recommended movement conditions associated with the route points, for moving the mobile body from a current position to a destination.

The term “route point” refers to data representing a specific location or state along a route, such as a waypoint including at least one of latitude, longitude, altitude, and a target time or speed.

The term “recommended movement condition” refers to data associated with a route point that specifies how the mobile body should move, including at least one of target speed, heading, altitude, or permitted deviation.

The term “no-go-zone information” refers to data representing regions in which movement of the mobile body is restricted or prohibited, such as controlled, hazardous, or regulated areas.

The term “safety and feasibility verification” refers to processing in which route points and associated movement conditions are evaluated against map information and no-go-zone information to determine whether the route points satisfy safety criteria and can be executed by the mobile body.

The term “corrected route information” refers to route information that has been modified, filtered, or adjusted based on safety and feasibility verification so as to comply with operational constraints and restrictions.

The term “estimated arrival time” refers to a predicted time at which the mobile body is expected to reach a destination or a specific route point, calculated based on corrected route information and movement conditions.

The term “state information” refers to data indicative of an operational status of the mobile body, including at least one of battery level, velocity, acceleration, health status of components, or communication quality.

The term “deviation” refers to a difference or discrepancy between the current position information and state information of the mobile body and corresponding values implied by the corrected route information.

The term “evacuation route” refers to route information that is generated for moving the mobile body from a current position to a safe location in response to detection of a hazard or increased risk.

The term “environment detection device” refers to any sensor system mounted on the mobile body that is configured to detect surrounding conditions, including at least one of distance sensors, cameras, weather sensors, or other environmental sensors.

The term “external information providing device” refers to any external server or service that supplies information about environmental conditions, including at least one of weather information, airspace restrictions, or hazard alerts.

The term “degree of risk” refers to a value or classification representing a level of danger to the mobile body or its operation, determined based on obstacle information, weather information, and other context data.

The term “threshold” refers to a predetermined value or condition used to decide whether the degree of risk requires generation of an evacuation route or other corrective action.

The server implements an embodiment of the invention as a backend computing platform that executes route planning and re-planning for a mobile body. The server comprises a processor, a memory, a network interface, and a storage device. The server runs an operating system such as a general-purpose server operating system and hosts application software modules implemented, for example, in a programming language suitable for numerical computation and service orchestration. The server also has access to a hardware accelerator such as a graphics processing unit configured for tensor computations, which is used for executing a generative AI model.

The server stores, in the memory, a route planning program that implements a set of functional modules, such as a data acquisition module, an environment state construction module, a prompt generation module, a generative AI inference module, a route validation and correction module, an estimated arrival time computation module, a telemetry monitoring module, and a dynamic re-prompting module. The server stores, in the storage device, a database that holds position information of the mobile body, map information, no-go-zone information, user-supplied constraints, and historical route data. The server accesses an external geographic information storage device via a communication network to retrieve map information including road information, obstacle information, and traffic information. The server also accesses external information providing devices, such as weather information servers and airspace restriction servers, to acquire environment information.

The terminal implements an embodiment as a user-operated computing device, such as a smartphone or a tablet. The terminal includes a processor, a memory, a display, input devices such as a touch panel, and a wireless communication interface. The terminal executes a client application that provides a graphical user interface for entering destination information and constraint condition information, for displaying the generated route, and for confirming or modifying delivery and movement commands. The terminal sends the entered information to the server over a communication network using secure application-layer protocols. The terminal receives route information and estimated arrival time from the server, and displays them as graphical overlays and textual indicators.

The user operates the terminal to specify a desired movement of the mobile body. The user enters, for example, a destination name, free-form natural-language instructions, and constraints such as a maximum allowed altitude or regions to avoid. The user confirms the planned route shown on the terminal and authorizes the server to control the mobile body autonomously along the generated route. The user can also issue mid-course instructions, such as emergency landing or return-to-home commands, which the terminal forwards to the server.

The server uses a position detection device mounted on the mobile body, such as a satellite positioning sensor in combination with an inertial measurement unit, to acquire position information. The server receives raw sensor signals from the mobile body over a wireless link and executes, in the data acquisition module, a sensor-fusion algorithm implemented as a numerical filter, such as an extended Kalman filter. The server converts raw measurements into normalized latitude, longitude, altitude, and velocity values, and stores them in the database together with timestamps. The server thereby maintains an internal data structure representing the current state of the mobile body, which is used as part of the environment state data.

The server uses an external geographic information storage device, such as a cloud-based geographic information server, to acquire map information. The server issues a query that contains a bounding region defined around the current position and the destination region and receives, in response, a data set that includes road information, obstacle information, traffic information, region boundaries, and elevation information. The server parses this data and represents it in graph-based and grid-based data structures in memory, where nodes correspond to locations or intersection points and edges correspond to possible movement segments annotated with attributes such as cost metrics, speed limits, and permissible altitude bands.

The server constructs environment state data by integrating the current position information, the map information, the destination information, and the constraint condition information. The environment state construction module transforms heterogeneous data into a unified internal representation. For example, the server discretizes the surrounding space into cells, associates each cell with features such as terrain type, obstacle density, traffic level, and legal restriction flags, and encodes user-specified constraints as additional features or masks over the cells and edges of the route graph. This environment state data forms the basis for generating a prompt sentence.

The server generates a prompt sentence as a textual sequence that encodes the environment state data in a compact, human-readable and machine-processable format. The prompt generation module constructs prompt sentences according to a predefined template. For example, the server generates a prompt sentence such as:
“The mobile body is currently at latitude 35.6580, longitude 139.7514, altitude 120 meters. The destination is Shibuya Station. Current wind speed is 8 meters per second from the west with light rain. Avoid restricted airspace and tall buildings, and minimize travel time. Generate an optimal aerial route and output a list of waypoints with latitude, longitude, altitude, and recommended speed for each waypoint.”

The server also uses another example prompt sentence such as:
“Replan the route from the current location at latitude 35.6600, longitude 139.7000 to Shibuya Station, avoiding storm cells to the southwest and staying at least 100 meters away from high-rise buildings. Produce updated waypoints that smoothly connect from the current path.”

The server uses these prompt sentences as inputs to a generative AI model. The generative AI inference module hosts or accesses a trained neural-network-based model deployed on the server or on an attached accelerator. In one embodiment, the server uses a transformer-based sequence model configured with multiple self-attention layers, feed-forward layers, and positional encodings. The model is trained offline using a large corpus of historical route data and simulated scenarios. The training procedure uses supervised learning with a loss function that combines trajectory error, safety violation penalties, and smoothness penalties. The server uses stochastic gradient descent or a related optimization method to adjust model parameters. During training, the server performs data augmentation such as random perturbation of starting positions, insertion of synthetic obstacles, and weather pattern variation to improve generalization.

The server uses an explicit feature encoding process when forming the prompt sentence so that essential attributes such as distance to obstacles, predicted wind impact, battery level, and legal restrictions are consistently embedded as textual patterns. Because the generative AI model has been trained to associate these patterns with high-quality routes, the model's inference step effectively performs a structured mapping from the prompt sentence to a sequence of route points and associated movement conditions. The server, rather than leaving this mapping abstract, constrains it via the template and feature encodings, which leads to more predictable and efficient computation.

The server receives the output of the generative AI model as a textual sequence that includes proposed waypoints and recommended movement conditions. The server parses this output using a deterministic parser that extracts numeric values for latitude, longitude, altitude, speed, and other attributes. The parsed route information is stored as a sequence of route points in a data structure such as a list or an array, with indexes corresponding to the order of traversal. Each route point is associated with metadata such as expected arrival time, margin to obstacles, and region identifiers.

The server performs safety and feasibility verification by running an algorithm that compares each route point and connecting segment against the map information and no-go-zone information. The server uses spatial indexing, such as a tree-based index or a grid index, to quickly query whether each point lies within restricted regions or intersects with known obstacles. The server also examines vertical profiles to ensure that altitude ranges avoid terrain and man-made structures. If violations are found, the server either removes points, adjusts their positions, or flags the route as requiring re-prompting. This verification step yields corrected route information that conforms to safety criteria and operational constraints, and effectively filters out any unsafe or physically infeasible suggestions from the generative AI model.

The server calculates estimated arrival time by aggregating segment-wise travel time estimates. For each pair of consecutive route points, the server computes the spatial distance using geodesic formulas and divides this distance by the recommended speed. The server adjusts segment times using correction factors derived from weather data, traffic conditions, and historical performance stored in the database. The server then sums the adjusted segment times to derive an estimated arrival time at the destination. This calculation uses vectorized numerical operations so that the route evaluation can be performed efficiently, improving processing speed compared with naive iterative computations.

The server transmits the corrected route information and the estimated arrival time to the mobile body and the terminal. The server encodes the route information in a communication format suited to the control system of the mobile body, such as a sequence of control waypoints with timing constraints, and sends it via a low-latency communication channel. The server also sends a summarized route description and the estimated arrival time to the terminal over a higher-level application protocol, enabling the user to visually confirm the planned route.

The server continuously receives telemetry from the mobile body, including current position information and state information such as speed, battery level, and sensor health. The telemetry monitoring module compares the live data with the corrected route information and calculates deviations. For example, the server computes lateral and longitudinal position errors, altitude deviations, and timing offsets. When deviations exceed predetermined thresholds, the dynamic re-prompting module constructs a new prompt sentence that explicitly encodes the deviation and updated environmental context. For instance, the server may generate a prompt sentence such as:
“The mobile body deviated 50 meters north of the planned route at waypoint 5 due to strong wind. Current position is latitude 35.6590, longitude 139.7400, altitude 110 meters. Recalculate a safe route to the same destination, taking into account increased wind from the north and maintaining a buffer of at least 80 meters from buildings.”

The server supplies this prompt sentence to the generative AI model and obtains an updated partial route. By iteratively closing this feedback loop between telemetry, prompt generation, generative inference, and safety verification, the server implements a closed-loop control architecture in which the generative AI model is tightly integrated into the control of the mobile body.

The server also accepts natural-language instructions from the user via the terminal. The server uses a natural-language analysis module to extract structured intent, such as “avoid flying over schools,” “stay below 150 meters,” or “prioritize safety over speed.” The server encodes these intents into constraint condition information and incorporates them both into the environment state data and into the prompt sentence template. This ensures that user preferences are not merely high-level labels but are converted into explicit computational constraints that influence the resulting route generation process.

The server thereby improves the functioning of the computer system in several ways. The environment state construction and prompt generation strategy reduces the amount of redundant or low-value data passed to the generative AI model, focusing the model's attention on relevant features and thus improving computation efficiency. The safety and feasibility verification module, combined with structured prompt encoding, reduces the frequency of unsafe or invalid routes, which in turn reduces the need for manual corrections and lowers communication overhead for route updates. The dynamic re-prompting architecture transforms the route planning process from a one-shot computation into an adaptive control loop, enabling faster convergence to safe routes under changing conditions and enhancing robustness compared with static heuristic approaches.

The terminal contributes to technical improvement by acting as a distributed interface and preprocessing unit. In some embodiments, the terminal performs local validation of user-provided destinations using a map software development kit and local caching. By normalizing addresses and resolving them to coordinates before transmission, the terminal reduces the server's computational load and shortens end-to-end latency. The terminal is further configured to aggregate user constraints in structured form, which reduces ambiguity in server-side processing.

The user benefits from reduced cognitive load and improved reliability of the system but does not perform the technical computation. Instead, the server orchestrates the acquisition, integration, encoding, model inference, verification, and distribution of route information in a manner that cannot be practically executed by a human operator in real time, especially under rapidly changing environmental conditions.

The server can use different generative AI model architectures in alternative embodiments. In one embodiment, the server uses a sequence-to-sequence model that takes as input a prompt sentence and outputs a textual description of waypoints. In another embodiment, the server uses a multimodal architecture that accepts both textual prompts and structured numerical embeddings representing environment state data. The server can also integrate an auxiliary network that predicts risk scores for candidate routes, and penalizes or rejects candidate outputs from the main generative model that exceed a risk threshold. This modular architecture allows variations in model design while preserving the technical effect of improved route planning.

The server can also support different types of mobile bodies. For an aerial vehicle, the server emphasizes altitude control and airspace restrictions, while for a ground vehicle, the server emphasizes road lanes, intersections, and traffic signals. In each case, the data structures for route points and movement conditions can be specialized but remain consistent with the overall framework of environment state construction, prompt generation, generative inference, safety verification, and dynamic re-prompting.

The described embodiments demonstrate that the invention is not limited to abstract information processing but is directly tied to the control of a physical mobile body through concrete hardware components and communication mechanisms. By specifying particular data structures, feature encodings, neural network architectures, training methods, and closed-loop feedback processes, the server improves the technical performance of the route planning system in terms of speed, accuracy, and robustness, and thereby provides a practical and implementable way to realize the claimed system.

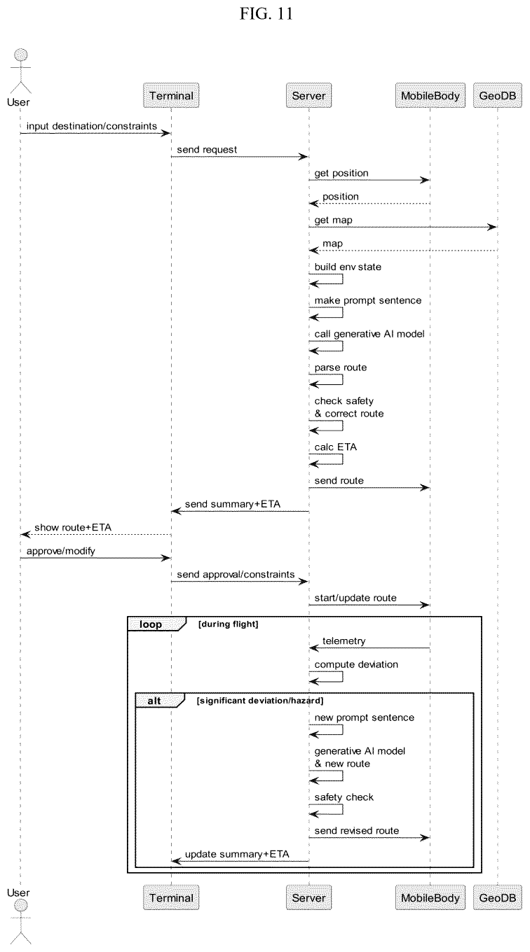

The following describes the processing flow using FIG. 11.

### Step 1:

The user operates the terminal to input destination information and constraint condition information.

The terminal displays an input screen that includes text fields for a destination name or address and optional fields for constraints such as maximum altitude, regions to avoid, or priority (speed versus safety).

Input: user-entered text and selections (destination string, constraint options).

The terminal converts the user's inputs into structured data, for example a destination record containing a normalized text string and a constraint record containing flags and parameter values.

Output: a request message including destination information and constraint condition information, formatted as structured data.

### Step 2:

The terminal transmits the request message to the server.

The terminal packages the destination information and constraint condition information into a request payload and sends it to the server over a secure communication channel.

Input: structured destination and constraint data created in Step 1.

The terminal serializes the data in a predetermined format and attaches user identification and timestamp metadata.

Output: a network message delivered to the server that contains all user input necessary for route planning.

### Step 3:

The server receives and stores the request data.

The server accepts the incoming network message, verifies its integrity and authentication, and parses the payload into internal data structures.

Input: network message from the terminal containing destination information and constraint condition information.

The server validates the data, assigns a unique request identifier, and stores the parsed content in a database table for pending route planning tasks.

Output: persisted request records including destination information, constraint condition information, and a request identifier.

### Step 4:

The server acquires current position information of the mobile body from a position detection device.

The server receives raw sensor signals from a satellite positioning sensor and an inertial measurement unit mounted on the mobile body.

Input: raw sensor measurements such as pseudorange data, accelerometer values, gyroscope readings, and timestamps.

The server executes a numerical filter to fuse these measurements, converts them into geographic coordinates (latitude, longitude, altitude) and velocity components, and normalizes the data into a standard coordinate system.

Output: position information of the mobile body represented as structured numeric data with associated timestamps.

### Step 5:

The server acquires map information from a geographic information storage device. The server issues a query to an external geographic information server via a communication network, specifying a region around the current position and the destination region. Input: position information of the mobile body from Step 4 and destination information from

### Step 3.

The server sends these parameters to the geographic information storage device, receives a response containing road information, obstacle information, traffic information, and elevation data, and parses the response into internal geographic data structures such as graphs and grids.

Output: map information records stored in memory and optionally cached for later reuse.

### Step 6:

The server constructs environment state data by integrating position information, map information, destination information, and constraint condition information.

The server aligns all data into a common spatial and temporal reference frame, associates map entities with positions relative to the mobile body and the destination, and encodes user constraints as numerical attributes and masks over the map representation.

Input: position information from Step 4, map information from Step 5, and request records containing destination and constraint condition information from Step 3.

The server computes derived features such as distances to nearest obstacles, estimated wind effects along candidate regions, legal restriction flags for each cell or segment, and allowed altitude intervals.

Output: environment state data represented as a structured data object that aggregates all relevant context for route generation.

### Step 7:

The server generates a prompt sentence based on the environment state data.

The server applies a prompt template that specifies how to convert numerical features and categorical attributes into a textual description.

Input: environment state data from Step 6.

The server formats the current position, destination, weather, obstacles, constraints, and objectives into a coherent natural-language instruction, for example:
“The mobile body is currently at latitude 35.6580, longitude 139.7514, altitude 120 meters. The destination is Shibuya Station. Current wind speed is 8 meters per second from the west with light rain. Avoid restricted airspace and tall buildings, and minimize travel time. Generate an optimal aerial route and output a list of waypoints with latitude, longitude, altitude, and recommended speed for each waypoint.”

The server combines sentence fragments with inserted numeric values to form the final prompt sentence.

Output: a prompt sentence expressed as a text string ready for input to the generative AI model.

### Step 8:

The server inputs the prompt sentence to a generative AI model and obtains draft route information.

The server calls an inference interface for a trained neural-network-based model, such as a transformer-based generative AI model deployed on a computation node with a graphics processing unit.

Input: prompt sentence from Step 7 and optional model parameters such as decoding temperature and maximum output length.

The server sends the prompt sentence to the model, triggers a forward pass through the neural network layers, and receives a generated textual output that describes a sequence of waypoints and movement conditions.

Output: generated text representing preliminary route information, including multiple waypoints and associated recommended movement conditions.

### Step 9:

The server parses the generated text into structured route information.

The server applies a deterministic parsing algorithm that recognizes patterns for latitude, longitude, altitude, and speed within the generated text.

Input: generated textual output from the generative AI model in Step 8.

The server extracts numeric values, converts them into floating-point coordinates and speeds, orders the waypoints according to their sequence in the text, and encapsulates them as route point records with metadata such as index and segment identifiers.

Output: structured route information comprising a list of route points and recommended movement conditions for each route point.

### Step 10:

The server verifies safety and feasibility of the route information and corrects the route as necessary.

The server compares each route point and route segment against the map information and no-go-zone information stored in memory.

Input: route information from Step 9 and map and no-go-zone information from Step 5. The server performs spatial queries using indexing structures to determine whether any route point lies within a restricted area or intersects with known obstacles, and checks whether recommended altitudes and speeds comply with operational limits. The server adjusts or removes unsafe route points and, if necessary, inserts intermediate points to smooth the path and maintain safe clearance distances.

Output: corrected route information that satisfies safety requirements and is physically feasible for the mobile body to follow.

### Step 11:

The server calculates an estimated arrival time based on the corrected route information. The server computes distances between consecutive route points and divides each distance by the corresponding recommended speed, then adjusts for environmental factors such as wind and traffic derived from the environment state data.

Input: corrected route information from Step 10 and environment features such as wind and traffic conditions from Step 6.

The server aggregates segment travel times to obtain a total travel time, adds this to the current time, and produces a predicted arrival time at the destination.

Output: an estimated arrival time value and, optionally, estimated arrival times for intermediate route points.

### Step 12:

The server transmits the corrected route information and the estimated arrival time to the mobile body.

The server formats the route points and movement conditions into a control message format compatible with the navigation system of the mobile body and attaches timing and safety parameters.

Input: corrected route information from Step 10 and estimated arrival time from Step 11. The server sends the control message over a low-latency wireless communication channel and awaits acknowledgment from the mobile body to ensure successful delivery.

Output: control messages received by the mobile body, enabling autonomous execution of the planned route.

### Step 13:

The server transmits a summary of the route and the estimated arrival time to the terminal. The server converts the corrected route information into a higher-level representation suitable for user visualization, such as a polyline and key waypoints, and includes the estimated arrival time.

Input: corrected route information from Step 10 and estimated arrival time from Step 11. The server sends this summary via an application-layer protocol to the terminal. Output: a response message that allows the terminal to display the planned route and arrival estimation to the user.

### Step 14:

The terminal receives the route summary and displays it to the user.

The terminal parses the response from the server, extracts the route polyline, key waypoints, and the estimated arrival time, and renders them on a map displayed on the screen. Input: route summary and estimated arrival time from Step 13.

The terminal converts geographic coordinates into screen coordinates using a map rendering library and overlays the route, while also presenting the estimated arrival time as a textual label.

Output: a graphical user interface that shows the planned route and the predicted arrival time to the user.

### Step 15:

The user reviews and optionally approves or modifies the route.

The user visually inspects the displayed route and the estimated arrival time and may decide to accept the route, request changes, or cancel the operation.

Input: displayed graphical representation of the route and estimated arrival time from Step 14. The user performs actions such as pressing an approval button or specifying additional constraints like “avoid this area” using touch gestures.

Output: user approval data or modification commands that the terminal converts into structured messages for the server.

### Step 16:

The terminal transmits the user's approval or modification commands to the server. The terminal captures the user's actions on the interface and formulates a control message that indicates route approval or additional constraints.

Input: user approval status and modification inputs from Step 15.

The terminal encodes new constraints or route adjustments as structured data and sends them to the server over the communication network.

Output: updated control or constraint messages delivered to the server.

### Step 17:

The server initiates or updates route execution based on user approval or modifications. The server checks the approval status, updates the stored request record, and, if modifications are present, incorporates new constraints into the environment state data and, if needed, generates a new prompt sentence and repeats Steps 7 through 11.

Input: control or constraint messages from Step 16 and existing environment state and route information.

The server either confirms the current route for execution or recalculates the route using the generative AI model and safety verification pipeline.

Output: finalized route information and control commands applied to the mobile body.

### Step 18:

The server monitors telemetry from the mobile body during route execution.

The server receives periodic telemetry messages containing current position information and state information such as speed, battery level, and sensor status.

Input: telemetry data from the mobile body as it moves along the route.

The server compares the telemetry-based positions with the corresponding planned route points, computes deviations in space and time, and records these metrics in a monitoring database.

Output: deviation metrics and updated internal state representing the real-time execution status of the route.

### Step 19:

The server dynamically re-prompts the generative AI model when deviations or hazards are detected.

The server analyzes deviation metrics and environmental updates, such as new obstacle or weather information, and decides whether the current route remains acceptable. Input: deviation metrics from Step 18 and any updated map or environment information obtained during execution.

When a significant deviation or hazard is found, the server builds a new prompt sentence that encodes the current position, the remaining distance to the destination, the nature of the deviation or hazard, and updated constraints. The server then sends this prompt sentence to the generative AI model, receives updated route segments, and subjects them to parsing and safety verification similar to Steps 8 through 10.

Output: revised route information that replaces or augments the remaining portion of the original route.

### Step 20:

The server transmits revised route information to the mobile body and updates the terminal. The server formats the revised route segments into control messages and sends them to the mobile body, while also generating a new route summary and revised estimated arrival time for the terminal.

Input: revised route information from Step 19.

The server ensures consistent handover between the old and new route segments by aligning the starting point of the revised route with the current position of the mobile body, then sends the updated control data and user-facing summary.

Output: updated control commands for the mobile body and refreshed route and arrival information displayed on the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented delivery management systems suffer from several technical limitations in coordinating autonomous transport bodies over wide-area communication networks. First, route computation and estimated time of arrival (ETA) prediction are typically implemented as static algorithms with fixed parameters. These algorithms run on conventional processors but are not able to flexibly adapt to complex constraints such as dynamic obstacles, rapidly changing environmental conditions, or operator-defined safety policies. As a result, the processor resources are not efficiently utilized, route calculation logic is difficult to update, and the quality of routing decisions, including ETA accuracy, is degraded.

Second, in many existing systems, the server and the transport body exchange only simple route and position messages. The server does not systematically integrate continuous position data, state data, and incident data (for example, obstacle or weather information) into an adaptive control loop. Consequently, when a route becomes unusable due to an obstacle or adverse weather, the processor must fall back to ad hoc or manual handling, which introduces latency, increases network traffic, and may cause inconsistent transport behavior. The lack of a structured mechanism to compute and issue evacuation routes to safe waiting positions leads to inefficient and sometimes unsafe operation of the autonomous transport bodies. Third, known systems do not effectively exploit generative AI models as programmable components of the routing pipeline. Generative AI models are either not used, or, if used, are invoked in isolation without a well-defined prompt generation mechanism that captures system state, geographic information, and operator policies. Without a processor-controlled prompt sentence generation process, the output of the generative AI model cannot be reliably aligned with the runtime constraints of the transport system. Moreover, conventional approaches do not allow operation policies, such as safety priority or avoidance of particular areas, to be dynamically injected into the routing logic via structured prompt sentences. This limits the ability of the computing system to evolve its behavior without redeploying traditional software components.

Fourth, the interaction between the server and user terminals is often limited to coarse-grained status updates. Existing implementations do not tightly couple continuous position tracking, updated ETA computation, and user-facing notifications in a way that leverages the processor's ability to aggregate and compute over time-series data. Users therefore receive outdated or inaccurate status information, and the communication channel between the server and the terminal is not fully utilized to reflect real-time behavior of the transport body. Accordingly, there is a need for a computer-implemented technique that improves the functioning of a server in an autonomous delivery environment by: (i) systematically acquiring and correlating transport body position, state, obstacle, and environment information; (ii) using a generative AI model under processor-controlled prompt sentence generation to compute transport routes, evacuation routes, and arrival prediction times; and (iii) dynamically updating transport control commands and user-facing information based on these computations. Such a technique should enable the processor to more flexibly and efficiently perform route calculation and evacuation decision processing, thereby improving reliability, safety, and responsiveness of the overall computer system, rather than merely automating a manual delivery workflow.

The specific processing by the specific processing unit 290 of the data processing device 12 in Application Example 1 is realized by the following means.

The present invention provides a server comprising a processor configured to acquire current position information of a transport body by using a position detection device; acquire geographic information for route calculation from a geographic information storage device via a communication network; receive delivery request information and destination information from a user terminal and, based on the delivery request information and the destination information, select the transport body and generate route calculation input data associating current position information of the transport body with the destination information; generate, based on the route calculation input data and the geographic information, a prompt sentence for causing a generative information processing model to calculate a transport route of the transport body and an estimated arrival time, input the prompt sentence to the generative information processing model, and obtain route information of the transport route and arrival prediction time information as an output of the generative information processing model; generate command information for instructing autonomous transport to the transport body based on the route information of the transport route and transmit the command information to the transport body; acquire current position information and state information that are transmitted at predetermined intervals from the transport body, collate the current position information and the state information with the route information of the transport route, update the arrival prediction time information based on a result of the collation, and generate transport status information including updated arrival prediction time information; transmit the transport status information to the user terminal and cause the user terminal to display at least a current position of the transport body and the arrival prediction time information; and determine, based on obstacle information and environment information transmitted from the transport body, whether continuation of transport is possible, and, when it is determined that continuation of transport is not possible, generate a prompt sentence to be input to the generative information processing model, obtain evacuation route information including a safe waiting position from the generative information processing model, and perform a waiting instruction to the transport body based on the evacuation route information. This enables the server-side computing system to improve route computation and evacuation control by internally generating structured prompt sentences that encode real-time system state and operation policies, invoking the generative information processing model as a dynamic routing component, and continuously updating transport commands and user-facing status information, thereby enhancing the technical performance, adaptability, and safety of autonomous transport management.

The term “processor” refers to a hardware-based or virtualized computation element, such as a central processing unit or a processing core in a computing device, that executes instructions and performs logical and arithmetic operations to implement the functions described in the present disclosure.

The term “transport body” refers to any autonomous or semi-autonomous physical conveyance unit, including a mobile robot, an unmanned vehicle, or a transportation platform, that is configured to move goods or items along a route under control of command information from a server.

The term “position detection device” refers to any sensing apparatus, such as a satellite positioning sensor, a global navigation receiver, or a localization sensor system, that generates data indicating a geographic position of an object, including the transport body.

The term “current position information” refers to data representing a present geographic position of the transport body, including at least coordinate values such as latitude and longitude, and optionally including altitude, accuracy, timestamp, and heading information.

The term “geographic information” refers to data representing spatial structures, roads, pathways, or other geographic features, including but not limited to map data, road network graphs, and associated attributes used for calculating or evaluating routes.

The term “geographic information storage device” refers to any storage subsystem, such as a database system, a file system, or a remote storage service, that stores geographic information retrievable by the processor over a communication interface.

The term “communication network” refers to any wired or wireless data communication infrastructure, including local networks, wide-area networks, and public networks, that enables data exchange between the server, the transport body, the user terminal, and other components.

The term “delivery request information” refers to data indicating a request to deliver at least one item from an origin to a destination, including information such as an item identifier, a quantity, and a requested time frame.

The term “destination information” refers to data specifying a target location for delivery, including at least an address or geographic coordinates, and optionally including constraints such as delivery time windows or access restrictions.

The term “user terminal” refers to any information processing apparatus operated by a user, such as a mobile device, a stationary computing device, or a display terminal, that is configured to transmit delivery request information and receive transport status information.

The term “route calculation input data” refers to data generated by the processor that combines current position information of the transport body, destination information, and relevant geographic information, and that serves as an input context for calculating a route.

The term “generative information processing model” refers to a machine-learned model, such as a generative artificial intelligence model, which is configured to generate output information, including route information and arrival prediction time information, in response to an input prompt sentence and contextual data.

The term “prompt sentence” refers to a structured textual or symbolic input sequence that encodes route calculation requirements, constraints, and contextual information, and that is provided to the generative information processing model to cause the model to perform a desired computation.

The term “transport route” refers to a path or sequence of positions, or segments thereof, calculated for the transport body to move from a starting position to a destination position while satisfying specified constraints.

The term “route information” refers to data representing the transport route, including at least an ordered sequence of waypoints or segments, and optionally including metadata such as estimated segment times, distances, and restrictions.

The term “arrival prediction time information” refers to data indicating an estimated time at which the transport body is predicted to arrive at a destination or at an intermediate point along the transport route, including timestamps or remaining time intervals.

The term “command information” refers to control data generated by the processor and transmitted to the transport body, instructing the transport body to perform actions such as starting movement, following a specific route, stopping, or waiting.

The term “autonomous transport” refers to movement of the transport body along at least a part of a route without human operation of actuators, based on command information and internal control logic of the transport body.

The term “state information” refers to data indicating an operational condition of the transport body, including at least a movement state, speed, or mode, and optionally including error statuses, battery level, or sensor health.

The term “transport status information” refers to data generated by the processor that summarizes a current state of a delivery operation, including at least current position information of the transport body and arrival prediction time information, and optionally including route progress and incident information.

The term “obstacle information” refers to data indicating presence, type, or location of an obstacle that may interfere with movement of the transport body along a planned route, such as a blocked road, a physical barrier, or unexpected object.

The term “environment information” refers to data describing environmental conditions around the transport body, including at least weather conditions, visibility, or road surface conditions, obtained from sensors or external information sources.

The term “evacuation route information” refers to data representing a route calculated for moving the transport body from a current position to a safe waiting position when continuation of transport along a planned route is not possible or is unsafe.

The term “safe waiting position” refers to a location, designated by configuration or calculated by the processor, at which the transport body can remain in a stationary or low-risk state while waiting for further instructions or for conditions to improve.

The term “operation policies” refers to configurable rules or preferences that influence route calculation and evacuation decisions, including factors such as prioritization of travel time reduction, safety emphasis, or avoidance of particular areas.

The term “setting information” refers to configuration data representing at least one operation policy, including parameters or flags used by the processor to adjust generation of prompt sentences and interpretation of outputs from the generative information processing model.

The term “processing procedure information” refers to data describing a sequence of computational steps, algorithmic structures, or parameter configurations, generated by the generative information processing model, and used by the processor to perform route or evacuation calculations.

The term “configuration information” refers to data specifying parameter values, constraint definitions, or structural selections for routing or evacuation algorithms, as generated or refined by the generative information processing model in response to a prompt sentence.

The term “management terminal” refers to an information processing apparatus operated by an administrator or operator, configured to transmit operation policy setting information to the server so as to control behavior of route and evacuation calculations.

In an embodiment, a server implements the claimed system as a network-connected computer device including at least one processor, a memory, a non-volatile storage device, and a network interface. The server executes a server program stored in the non-volatile storage device and loaded into the memory. The server program is implemented, for example, using a general-purpose operating system and an application framework, and is configured to coordinate a plurality of transport bodies and a plurality of user terminals via a communication network.

The server uses a position detection device associated with each transport body to obtain current position information. The position detection device includes, for example, a satellite-based positioning module or a global navigation sensor that generates raw position signals. The transport body preprocesses these signals using an embedded controller and transmits position data including latitude, longitude, timestamp, and heading to the server via a wireless communication module using a protocol such as an HTTP-based protocol or a publish/subscribe messaging protocol. The server stores the received position data in a data structure, such as a time-series table indexed by transport body identifier and timestamp, within a database management system.

The server accesses a geographic information storage device to obtain geographic information for route calculation. The geographic information storage device is realized, for example, by a geographic database server that stores road network data, node and edge identifiers, permitted directions, speed limits, typical travel times, and constraint attributes such as one-way restrictions and prohibited areas. The server queries the geographic information storage device using a structured query interface. The geographic information is stored internally in a graph data structure, where each road segment is represented as an edge with attribute fields for length, typical travel time, risk score, and permitted vehicle types. The server receives delivery request information and destination information from a user terminal. The user operates the user terminal, which is realized by a mobile computing device or a stationary computing device, to input at least item information and a destination address. The terminal program running on the user terminal packages this information into a structured request, adds a user identifier, and transmits it to the server via the communication network. The server parses the delivery request information and uses an address resolution service to convert the destination address into geographic coordinates. The server then selects a transport body based on selection metrics such as spatial proximity, current load, and remaining energy, and associates the selected transport body with the delivery request in internal tables.

The server generates route calculation input data by combining the current position information of the selected transport body, the destination geographic coordinates, and relevant geographic information extracted from the graph data structure. The route calculation input data is represented as a feature vector sequence describing candidate path segments, including at least start and end node identifiers, segment lengths, known traffic characteristics, and risk values. The server normalizes these feature values and assembles them into a context representation used by a generative information processing model. The server uses a generative AI model as the generative information processing model. In one embodiment, the generative AI model is realized by a neural network-based language model optimized for route planning instructions. The model has an encoder-decoder architecture with multiple attention layers. The encoder receives tokenized prompt sentences, and the decoder generates output tokens representing route information and arrival prediction time information. The network parameters of the model are stored in the server's storage device and loaded into system memory when the model is invoked.

The server generates a prompt sentence to be input to the generative AI model. The server constructs the prompt sentence as natural-language text including explicit fields describing the current position, destination position, constraints, and optimization objectives. For example, the server generates a prompt sentence such as:
“Calculate an optimal transport route for an autonomous delivery vehicle from current coordinates (35.0000, 139.0000) to destination coordinates (35.0500, 139.0500). Use the provided road network graph and segment travel time statistics. Minimize expected arrival time while avoiding segments marked as restricted. Output the route as an ordered list of node identifiers and provide an estimated arrival time in minutes.”

In another example, the server generates a prompt sentence for evacuation routing such as: “Given that the current delivery route is blocked due to an obstacle at node N1234, compute a safe evacuation route from the current position of the vehicle to the nearest designated safe waiting position. Use safety scores associated with each road segment and prioritize routes with higher safety scores even if travel time is increased. Output the evacuation route as an ordered list of node identifiers and provide an estimated remaining time to reach the safe waiting position.”

The server tokenizes the prompt sentence, converts tokens into numerical embeddings using an embedding matrix of the neural network model, and provides the embeddings to the encoder portion of the generative AI model. The server may additionally append structured context tokens that encode settings such as “safety_priority-high” or “avoid_area_ids=[A15, A16]”. The encoder generates context vectors via multi-head self-attention and feed-forward layers. The decoder attends to these context vectors and generates output tokens that are decoded back into a structured representation of route information and arrival prediction time information.

The server parses the output of the generative AI model to form route information. In one embodiment, the model output includes a textual sequence such as “Route: N1001->N1010->N1100, ETA: 14 minutes.” The server uses a pattern parser to extract node identifiers and an ETA value. The server then maps the node identifiers to graph nodes in the geographic information structure and generates a route information record comprised of an ordered list of waypoints, each waypoint including geographic coordinates and associated attributes. The arrival prediction time information is stored as a timestamp computed by adding the predicted remaining time to the current server time.

The server generates command information to instruct autonomous transport. The server formats the route information into a compact message format, specifying waypoints, desired speeds, and control modes. The server transmits this command information to the transport body via the communication network. The transport body uses its onboard controller and actuator control program to execute the movement along the specified waypoints, thus tightly coupling the server-side route computation with physical movement of the transport body in the real world.

The server acquires current position information and state information transmitted at predetermined intervals from the transport body. The state information includes movement state, speed, current command index, sensor health, and error codes. The server uses a tracking module to collate the received position with the stored route information by computing the nearest waypoint and the progress ratio along the route. The server re-computes a refined arrival prediction time by combining the remaining distance to the destination with an estimated speed profile. The estimated speed profile is derived from a historical performance table or from output of the generative AI model configured to predict time per segment based on recent observations.

The server generates transport status information that includes the updated arrival prediction time, the current location, and route progress. The server transmits this transport status information to the user terminal. The user terminal displays a map view with the current position of the transport body and the estimated arrival time. The user visually observes the updated status and does not need to perform manual route calculation or estimation. The server further acquires obstacle information and environment information from the transport body. Sensors mounted on the transport body, such as vision sensors, distance sensors, and environment sensors, detect deviations such as blocked segments or unfavorable weather. The transport body summarizes such detections into obstacle information and environment information transmitted to the server. The server evaluates these reports with reference to stored route information and geographic constraints. The server determines whether continuation of transport is possible by applying decision rules that include thresholds for allowable delay, safety scores for segments, and sensor reliability indicators. When the server determines that continuation of transport along the current route is not possible, the server generates a new prompt sentence targeted for evacuation route generation, as described above. The prompt sentence includes identification of prohibited segments, ranking of safe waiting positions stored in a safe-location table, and a safety-priority parameter. The server then invokes the generative AI model with the new prompt sentence. The generative AI model outputs a new route that leads from the current position of the transport body to a safe waiting position. The server parses this output into evacuation route information and generates new command information instructing the transport body to move to the safe waiting position. This results in timely and safe relocation of the physical transport body even under adverse conditions.

The server enables dynamic modification of routing behavior via operation policies. A management terminal is operated by an administrator to input operation policy setting information such as “prioritize safety over speed at night,” “avoid specified geographic regions,” or “limit maximum route length in high-congestion areas.” The server receives these settings and encodes them into internal policy parameters. When generating prompt sentences for the generative AI model, the server inserts descriptive phrases or tokens reflecting these policies. For example, the server may generate a prompt sentence such as:

“Optimize the route for maximum safety at nighttime conditions. Avoid segments with safety_score below 0.4 and avoid region R20. Minimize expected risk even if travel time increases.”

By programmatically injecting policy-derived constraints into the prompt sentence, the server changes the behavior of the generative AI model without redeploying conventional code. The server interprets and applies the model's output in a way that dynamically reflects updated operation policies.

The server improves computer technology by defining specific data structures, model configurations, and processing flows. For example, the server uses a graph-based representation of the road network and maintains a time-series database of vehicle positions. The generative AI model consumes these structured data as contextual tokens rather than operating on unstructured text alone. The server's prompt generation module transforms high-dimensional route context into a compressed textual representation optimized for the generative AI model's architecture. This allows the server to offload complex route search and constraint balancing from traditional deterministic algorithms to the generative AI model. The result is a reduction in computation time for route recalculation, particularly when constraints change dynamically, because the model can infer a near-optimal route by performing a single forward pass over the neural network rather than repeatedly executing graph search algorithms.

In one embodiment, the generative AI model is trained offline with a combination of supervised and reinforcement learning methods. The server prepares training data by recording historical routes, actual travel times, and incident outcomes. Each training sample includes an input representation composed of route context tokens and policy tokens, and an output representation describing a recommended route and predicted travel time. The server trains the model by minimizing a loss function that combines a sequence prediction loss and a time prediction loss, such as a cross-entropy term for route token accuracy and a mean-squared-error term for arrival time accuracy. The server updates model weights using gradient-based optimization and periodically retrains or fine-tunes the model using new operational data. As a result, the model learns patterns of road usage, congestion, and incident response that are not easily encoded in static rule sets, thereby improving ETA precision and route quality.

The server reduces communication load by aggregating and processing status information before notifying user terminals. Rather than sending raw position data at high frequency to each user terminal, the server performs interpolation and ETA recalculation internally and transmits high-level transport status information at intervals tuned to user needs. This reduces network bandwidth usage and processing load on the user terminals while maintaining accurate and timely information for the user.

The server also exhibits technical effects beyond mere automation of human planning. Traditional human route planners cannot feasibly combine a full road network graph, dynamic vehicle telemetry, and real-time sensor incidents at high temporal resolution. In contrast, the server continuously ingests these data streams, transforms them into structured representations, and uses the generative AI model to compute routes and evacuation strategies that satisfy multi-dimensional constraints. This produces technical improvements in route accuracy, ETA stability, and responsiveness to incidents. The improvement is causally linked to the defined configuration of the server, including the particular arrangement of sensors, databases, data structures, the generative AI model architecture, and the prompt generation and parsing procedures.

The terminal operates as a user-facing interface but also contributes to technical performance. The terminal reduces unnecessary polling by reacting to push notifications sent by the server when significant events occur, such as a large ETA change or a route change due to an obstacle. The terminal maintains a local cache of the latest transport status information and renders it using a map component. This architecture reduces server load and avoids redundant data transfers, contributing to efficient utilization of network and processor resources. The user interacts with the system but does not need to understand the internal routing logic. The user simply submits delivery requests and monitors the transport status. The user receives more accurate and stable ETA information compared to conventional systems because the server's computational pipeline is optimized for continuous learning and dynamic constraint handling, not for fixed heuristic-based route planning.

Variations of the embodiment are possible. In one variation, the server deploys multiple generative AI models specialized for different types of transport bodies, such as ground robots and aerial vehicles, and selects an appropriate model based on the type of transport body. In another variation, the server combines outputs of a conventional graph search algorithm and the generative AI model, using the graph search algorithm to verify feasibility and the model to propose candidate routes that satisfy complex policy constraints. In yet another variation, the server uses different prompt templates for normal delivery routing and for emergency evacuation routing, enabling further optimization of model performance. Through these configurations and variations, the server, terminal, and user cooperate to realize an autonomous delivery environment in which the server performs concrete technical processing on hardware resources and stored data structures, the generative AI model is invoked via precisely constructed prompt sentences, and physical transport bodies are controlled in real time. This leads to improved processing speed, higher ETA accuracy, reduced communication load, and enhanced safety, an effect that directly results from the technical arrangement and processing flow of the system.

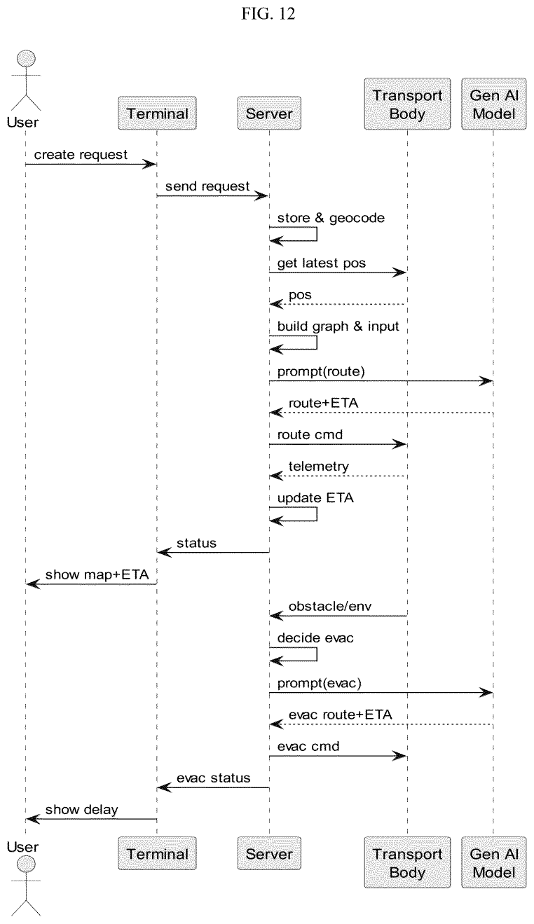

The following describes the processing flow using FIG. 12.

### Step 1:

The user operates the terminal to create a delivery request.

The user launches an application on the terminal and inputs item information (for example, type of goods and quantity) and a destination address.

Input: User's manual input via graphical interface elements (text fields, selection lists).

Output: Structured delivery request data held in the terminal's memory (including item data, destination address text, and user identifier).

The terminal converts the user's inputs into a structured data object in memory, validates required fields (such as non-empty address and valid quantity), and prepares the data for transmission to the server.

### Step 2:

The terminal transmits the delivery request information to the server.

The terminal creates a network request message containing the delivery request data and sends it over a communication network to the server.

Input: Structured delivery request data stored in the terminal.

Output: A network message delivered to the server and a local transmission status in the terminal.

The terminal uses a communication library to serialize the delivery request into a message format, attaches a timestamp and authentication token, and sends the message to a predefined server endpoint. The terminal then waits for an acknowledgment or response.

### Step 3:

The server receives and stores the delivery request information.

The server accepts the network message, parses the delivery request, and records it in a persistent storage subsystem.

Input: Network message containing the delivery request data.

Output: A delivery request record stored in a database and an internal request identifier. The server deserializes the message into an internal data structure, verifies the integrity and authenticity of the message, and inserts a new record into a database table that stores fields such as request identifier, user identifier, destination address, and request time. The server generates a unique identifier for the new request.

### Step 4:

The server resolves the destination address to geographic coordinates.

The server converts the destination address text into numeric geographic coordinates for route planning.

Input: Destination address text from the stored delivery request record.

Output: Destination geographic coordinates (for example, latitude and longitude) associated with the delivery request.

The server calls an address resolution component, which may query a geographic information storage device or an external geocoding service. The component performs text normalization and matching against stored address records or map data, then computes latitude and longitude values. The server writes the resulting coordinates into the delivery request record.

### Step 5:

The server selects an appropriate transport body for the delivery request.

The server chooses a transport body based on its current state and position.

Input: Delivery request record with destination coordinates, and status records of available transport bodies.

Output: A selected transport body identifier linked to the delivery request.

The server retrieves current status information of transport bodies from a status table, including position, battery level, current load, and availability flags. The server computes a suitability score for each candidate, for example by calculating distance to the pickup or origin point and checking remaining energy. The server selects the transport body with the best score and updates the delivery request record to reference the chosen transport body.

### Step 6:

The server acquires current position information of the selected transport body.

The server uses position data received from the transport body's position detection device.

Input: Transport body identifier and latest position records stored in a time-series database.

Output: Current position information for the selected transport body.

The server queries the time-series database for the most recent entry corresponding to the selected transport body. The entry includes latitude, longitude, timestamp, and possibly heading and speed. The server extracts these fields into a dedicated in-memory object representing the current position information.

### Step 7:

The server retrieves geographic information needed for route calculation.

The server loads relevant portions of the road network and associated attributes from the geographic information storage device.

Input: Current position coordinates of the transport body and destination coordinates; geographic information storage (road network graph).

Output: A subgraph of the road network including nodes and segments between the current position and the destination.

The server computes a bounding region that covers the area from current position to destination and queries the geographic information storage device for all road segments intersecting this region. The server assembles these segments and nodes into a graph data structure in memory, with attributes such as segment length, speed limit, and restriction flags.

### Step 8:

The server constructs route calculation input data.

The server combines transport body position, destination coordinates, and geographic graph information into a unified representation.

Input: Current position information, destination coordinates, and the subgraph of the road network.

Output: Route calculation input data including features for each candidate segment or node. The server generates data elements for each segment, including segment identifier, start node identifier, end node identifier, length, typical travel time, and any restriction flags. The server normalizes these numerical values and encodes categorical attributes as numerical codes. The server assembles these into a sequence or matrix representation suitable for downstream processing.

### Step 9:

The server generates a prompt sentence for a generative AI model.

The server produces a structured natural-language text that describes the routing problem and constraints.

Input: Route calculation input data, operation policy settings, and current system state.

Output: A prompt sentence to be consumed by the generative AI model.

The server reads operation policy parameters such as “minimize travel time,” “avoid restricted areas,” and “safety priority level” from configuration storage. The server then formats a prompt sentence, inserting numerical values for coordinates, policy parameters, and relevant identifiers. For example, the server may create a prompt sentence:

“Calculate an optimal transport route from current coordinates (X1, Y1) to destination coordinates (X2, Y2). Use the road network with segment travel time statistics. Minimize expected arrival time while avoiding restricted segments. Output the route as an ordered list of node identifiers and an estimated arrival time.”

The server writes the resulting text into a buffer designated as the prompt sentence.

### Step 10:

The server invokes the generative AI model with the prompt sentence.

The server processes the prompt sentence using a neural network configured as a generative information processing model.

Input: Prompt sentence constructed in Step 9.

Output: Generated output text containing route information and estimated arrival time. The server tokenizes the prompt sentence into discrete tokens, maps each token to an embedding vector using a stored embedding matrix, and feeds the sequence of embeddings into the encoder of the generative AI model. The encoder and decoder perform matrix multiplications, non-linear activations, and attention computations to produce an output token sequence. The server decodes this token sequence into output text, which may include a description of the route and an ETA.

### Step 11:

The server parses the generative AI model output to extract route information and arrival prediction time information.

The server converts the generated text into structured data for further processing. Input: Output text from the generative AI model.

Output: Route information (for example, an ordered list of node identifiers or coordinates) and arrival prediction time information (for example, minutes or a timestamp). The server applies pattern matching and parsing rules to the output text to identify tokens corresponding to route elements and ETA values. The server transforms node identifiers into nodes of the internal graph data structure, and converts the ETA value into a time interval or absolute time by adding it to the current server time. The server stores these results in a route record associated with the transport body and delivery request.

### Step 12:

The server generates command information for autonomous transport.

The server transforms the route information into control instructions for the transport body.

Input: Route information and arrival prediction time information.

Output: Command information including waypoints, speeds, and control parameters transmitted to the transport body.

The server calculates waypoints by mapping route nodes to geographic coordinates and may compute recommended speed profiles for different segments based on typical traffic conditions. The server packages these waypoints and parameters into a compact control message and sends it to the transport body's controller via the communication network.

### Step 13:

The transport body executes movement based on the command information, and the server monitors position updates.

The server receives continuous telemetry from the moving transport body.

Input: Command information issued by the server; periodic telemetry messages from the transport body containing current position and state information.

Output: Updated internal state in the server reflecting the real-time position and state of the transport body.

The transport body follows waypoints using its onboard controller. The server listens for telemetry messages and updates its time-series database with the new position and state information. The server computes the index of the nearest waypoint reached and marks progress along the route.

### Step 14:

The server recalculates or refines arrival prediction time based on real-time telemetry. The server updates the ETA when new position and state data arrive.

Input: Current position information and state information from the transport body; stored route information with remaining distance.

Output: Updated arrival prediction time information.

The server calculates the remaining distance along the route by summing lengths of segments yet to be traversed. The server estimates average speed based on recent speed observations and typical segment travel times. The server divides remaining distance by estimated speed to obtain a remaining time estimate, then adds this to the current time to compute an updated ETA. The server overwrites or stores this updated ETA in the route record.

### Step 15:

The server generates transport status information and notifies the terminal.

The server summarizes the current transport state and sends it to the user terminal.

Input: Current transport body position, state information, route progress, and updated ETA.

Output: Transport status information message containing at least current position and updated ETA transmitted to the terminal.

The server constructs a status object with fields for current location coordinates, percentage of route completed, and ETA. The server transmits this object via a network message or push notification mechanism to the user terminal.

### Step 16:

The terminal displays the received transport status information to the user.

The terminal updates its user interface to reflect the current delivery status.

Input: Transport status information message from the server.

Output: A visual representation on the terminal screen showing transport body position and ETA.

The terminal parses the incoming status information, updates a local status cache, and instructs a map display module to position a marker at the current coordinates. The terminal also updates a text label indicating the estimated arrival time, thereby providing the user with a real-time view of the delivery.

### Step 17:

The server processes obstacle information and environment information from the transport body.

The server evaluates whether the planned route remains viable given newly reported conditions.

Input: Obstacle information and environment information messages from the transport body; current route information and policy settings.

Output: A decision as to whether to continue the current route or to initiate evacuation routing.

The server reads obstacle type, location, and severity from the message and compares the obstacle location with segments of the current route. The server also inspects environment indicators such as weather status and sensor confidence scores. Based on rules or thresholds (for example, blocked segment or hazardous weather level), the server sets a flag indicating whether the route remains usable.

### Step 18:

The server generates a new prompt sentence when evacuation routing is required. The server prepares a prompt sentence specifying the need for a safe waiting position route.

Input: Current position information, known obstacles and hazardous regions, safe waiting positions stored in a database, and operation policy settings.

Output: An evacuation prompt sentence for the generative AI model.

The server selects candidate safe waiting positions from a safe-location table based on proximity and safety score. The server then composes an evacuation-oriented prompt sentence, for example:
“Given that the delivery route from current coordinates (X1, Y1) to destination (X2, Y2) is blocked at segment S123, compute an evacuation route from the current position to the nearest safe waiting position. Use safety scores for each segment and avoid segments with safety_score below 0.5. Output the evacuation route as an ordered list of node identifiers and the estimated time to reach the safe waiting position.”

The server stores this text as the evacuation prompt sentence.

### Step 19:

The server invokes the generative AI model with the evacuation prompt sentence and generates evacuation route information.

The server computes a new route guiding the transport body to a safe waiting position.

Input: Evacuation prompt sentence and associated context.

Output: Evacuation route information and evacuation arrival prediction time information. The server tokenizes the evacuation prompt, processes it through the generative AI model, and decodes the model's output into text. The server then parses the text to extract an ordered list of nodes and an estimated time to reach the safe waiting position. The server maps the node list onto the internal graph to generate a structured evacuation route.

### Step 20:

The server issues evacuation command information to the transport body and updates the user terminal.

The server instructs the transport body to follow the evacuation route and informs the user.

Input: Evacuation route information and evacuation ETA; current user contact information and terminal identifiers.

Output: Evacuation command information transmitted to the transport body and updated status notifications sent to the terminal.

The server converts the evacuation route into waypoints and control parameters, similar to normal routing, and transmits these commands to the transport body. Simultaneously, the server generates updated transport status information indicating that an evacuation procedure is in progress and sends a notification to the user terminal. The terminal displays a message explaining the delay and the new estimated time for resuming or completing delivery.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional route-planning and autonomous transportation systems typically rely on fixed algorithms and static rule sets that are executed on general-purpose computer hardware. Such systems suffer from several technical limitations. First, they are not well adapted to ingest and jointly process heterogeneous, dynamic data sources such as geographic data, environmental data, sensor data from moving bodies, and user-request data in real time. As a result, the routing logic is often simplified, leading to suboptimal route computation and inefficient utilization of network and processing resources.

Second, in many existing architectures, a route is computed once by a deterministic routing engine and then merely stored and forwarded to a moving body, such as an unmanned vehicle, without dynamically updating the route in response to changes in environmental conditions, obstacles, or status of the moving body. This static approach causes frequent mission interruptions, unnecessary detours, or conservative fallback behavior, thereby degrading system throughput, increasing processor load for repeated re-planning cycles, and generating redundant communication traffic.

Third, where machine learning models are used, they are typically invoked as black-box components with fixed input formats, and the host computer system lacks a structured mechanism to generate and manage prompt sentences tailored to the current context. Without context-specific prompt generation and integration of up-to-date geographic and environmental information, the computing system cannot fully exploit the ability of a generative AI model to synthesize optimized route data. This leads to inefficient model usage, higher latency due to repeated calls with poorly structured inputs, and unstable behavior in edge cases.

Fourth, conventional systems do not tightly couple model outputs with low-level control command generation for moving bodies. Often, an additional translation layer is implemented in an ad hoc manner, which increases processing overhead on the host processor and can introduce inconsistencies between high-level route planning and low-level control. This weak coupling also hinders real-time reconfiguration of control commands when environmental conditions change, thereby limiting the responsiveness and reliability of the overall computing system.

Fifth, conventional notification mechanisms are usually external to the routing logic and do not leverage the same integrated data pipeline. Estimated arrival times are often computed using simplistic distance and speed approximations without using the detailed route points, environmental conditions, and current state of the moving body maintained in the routing engine. This separation causes inconsistent status information to be provided to user terminals, reduces predictability, and complicates system integration, thereby increasing the overall computational complexity and maintenance cost.

Accordingly, there is a need for an improved computer-implemented system and server architecture that (i) integrates acquisition of position information, geographic information, environmental information, and user-request information, (ii) programmatically generates context-aware prompt sentences and supplies them together with structured data to a generative AI model, (iii) converts rich model outputs into executable control command sequences for moving bodies, and (iv) dynamically recalculates routes or retreat paths and estimated arrival times based on continuously updated sensor information and environmental information. Such a system should improve the efficiency, adaptability, and reliability of the underlying computer technology used for route computation, control-command generation, and notification processing, thereby achieving improved performance of the computing system as a whole.

The specific processing by the specific processing unit 290 of the data processing device 12 in Example 2 is realized by the following means.

The present invention provides a server comprising a processor and a memory storing instructions that, when executed by the processor, cause the processor to acquire a current position of a moving body by using a position acquisition device, obtain geographic information and environmental information from a storage device via an information communication network, generate a prompt sentence for instructing a generative AI model to calculate an optimal route based on the geographic information and the environmental information, input the prompt sentence together with the geographic information and the environmental information to the generative AI model, acquire route information output from the generative AI model including a plurality of route points and movement conditions, convert the route information into a sequence of control commands for the moving body, transmit the sequence of control commands to the moving body by using a wireless communication unit, generate an additional prompt sentence for instructing the generative AI model to perform recalculation of a route or calculation of a retreat route based on position information and state information acquired from the moving body and based on the environmental information, input the additional prompt sentence to the generative AI model, calculate an estimated arrival time based on the position information of the moving body and the route information, and transmit notification information including the estimated arrival time to an information terminal. This enables a computer system to more efficiently process heterogeneous spatial and environmental data, to dynamically generate and refine optimal or safe routes through context-sensitive interaction with a generative AI model, to automatically translate model outputs into low-level control command sequences for moving bodies, and to provide accurate, real-time arrival predictions to user terminals, thereby improving overall computational performance, responsiveness, and reliability of route-planning and autonomous transportation operations.

The term “processor” refers to a hardware computing element, such as a central processing unit or a computing core, that executes instructions stored in a memory to perform logical, arithmetic, control, and input/output operations.

The term “memory” refers to a hardware storage element, such as a volatile or non-volatile storage device, that stores executable instructions and data for access by a processor.

The term “position acquisition device” refers to a hardware component or sensor subsystem, such as a satellite-based positioning receiver or equivalent location sensor, that obtains position information of a moving body.

The term “moving body” refers to any controllable mobile apparatus, such as an unmanned vehicle or autonomous transport device, that is capable of moving along a route in response to control commands.

The term “information communication network” refers to a communication infrastructure, such as a wired or wireless packet-switched network, that enables data exchange between the server, storage devices, moving bodies, and information terminals.

The term “storage device” refers to a hardware data storage resource, such as a local or remote database system or file storage system, that stores geographic information, environmental information, or other related data.

The term “geographic information” refers to data representing spatial characteristics of an area, including but not limited to coordinates, maps, terrain features, and boundaries relevant to route calculation.

The term “environmental information” refers to data representing external conditions that affect movement of a moving body, including but not limited to weather conditions, obstacles, traffic conditions, or airspace restrictions.

The term “generative AI model” refers to a machine-learned computational model, such as a neural network, that is configured to generate output data, including route information, in response to input data and a prompt sentence.

The term “prompt sentence” refers to a machine-readable natural language or structured instruction that specifies a task or requirement to be performed by a generative AI model, such as calculating an optimal route or a retreat route.

The term “route information” refers to data output from a generative AI model that defines a planned path for a moving body, including a plurality of route points and associated movement conditions.

The term “route point” refers to an element of route information that specifies a spatial location, such as a coordinate, at which a moving body is intended to pass or perform a maneuver.

The term “movement conditions” refers to parameters associated with route points, such as speed, altitude, or timing constraints, that define how a moving body is to traverse the route.

The term “sequence of control commands” refers to an ordered set of control instructions that are interpretable by a control system of a moving body and that cause the moving body to follow a route or perform specific maneuvers.

The term “wireless communication unit” refers to a communication subsystem, such as a radio transceiver, that performs wireless data transmission and reception between the server and a moving body or between the server and an information terminal.

The term “position information” refers to data indicating a location of a moving body, such as coordinates or altitude, which may be obtained from a position acquisition device.

The term “state information” refers to data indicating an operational condition of a moving body, such as battery level, velocity, orientation, system status, or sensor readings.

The term “retreat route” refers to a route calculated for moving a moving body from a current position to a safe location when continuation toward an original destination is determined to be unsafe or inefficient.

The term “estimated arrival time” refers to a predicted time at which a moving body is expected to reach a particular location, such as a destination, based on route information, position information, and movement conditions.

The term “notification information” refers to data generated for presentation to an information terminal, including at least status information of a moving body or an estimated arrival time.

The term “information terminal” refers to an end-user computing device, such as a portable communication device or a client terminal, that is configured to transmit delivery request information and to receive and present notification information.

The term “delivery request information” refers to data provided from an information terminal that specifies a transportation request, including at least destination information and package information.

The term “destination information” refers to data indicating a target location for delivery or movement, such as an address or coordinates.

The term “package information” refers to data describing an item to be transported, such as weight, size, or handling requirements.

In one embodiment, a server, a terminal, and a moving body such as an unmanned aerial vehicle cooperate to implement the claimed system. The server includes at least one processor, a memory, a wireless communication unit, and network interfaces connected to an information communication network. The terminal includes a processor, a memory, a user interface, and a wireless communication unit. The moving body includes a flight controller, a position acquisition device, one or more sensors, and a wireless communication unit. The server stores and executes a program that configures the processor of the server to perform the functions described below.

The server uses a general-purpose processor such as a multi-core central processing unit and, in some embodiments, a graphics processing unit configured for numerical acceleration. The server stores a trained generative AI model in the memory. The generative AI model is implemented by a neural network library, such as a tensor-based computation framework, and has a network architecture including an encoder-decoder structure with multiple attention layers. The encoder component receives tokenized prompt sentences and structured numeric features, and the decoder component outputs a sequence of route points with associated movement conditions.

The server stores geographic information and environmental information in a storage device such as a relational database, a spatial database, or a distributed file system. The geographic information includes map tiles, road network graphs, building footprint polygons, terrain elevation grids, and precomputed spatial indices. The environmental information includes weather observations, weather forecasts, airspace restriction polygons, obstacle locations, and historical traffic data. The server organizes these data in specific data structures, for example, key-value tables indexed by geographic region identifiers and time identifiers, and spatial indices that allow rapid retrieval of elements intersecting a corridor along a candidate route. The terminal runs a dedicated application that allows a user to enter destination information and package information. The terminal converts user input into structured data fields such as coordinates, text descriptions, and numerical values. The terminal transmits delivery request information to the server over the information communication network, using a secure transport protocol. The terminal receives notification information from the server and presents arrival estimates and status information on a graphical user interface.

The server generates prompt sentences to control the behavior of the generative AI model. The server constructs each prompt sentence as a natural-language string that describes the current technical task and constraints. For example, the server generates a prompt sentence such as:
“Using current weather, terrain elevation, and no-fly zones, generate an optimal aerial delivery route from the origin coordinates to the destination coordinates. Output a sequence of waypoints with latitude, longitude, and altitude, and output a recommended speed for each segment.”

In another example, when a new restriction is detected, the server generates:
“From the current drone position, generate a safe and efficient diversion route to the original destination, avoiding new no-fly zones and regions with wind speeds above 15 meters per second.”

In a further example, when a retreat is required, the server generates:
“Given the current drone position and known safe landing locations, determine the safest immediate landing location and generate a retreat route to that location that minimizes exposure to strong winds and high obstacle density.”

The server tokenizes each prompt sentence using a tokenizer associated with the generative AI model and converts each token into an embedding vector. The server also converts the geographic information and environmental information into feature tensors. For instance, the server samples terrain elevation along a corridor surrounding the origin and destination and forms a matrix of elevation values; the server encodes wind speed, wind direction, and precipitation as numeric feature vectors associated with spatial cells; and the server encodes no-fly zones as polygon masks in a raster grid. The server concatenates or otherwise fuses the language embeddings and the structured feature tensors into a unified model input representation.

The server executes the generative AI model on the processor. The model applies multiple layers of linear transformations, non-linear activation functions, multi-head attention, and normalization to propagate information through the network. The decoder outputs a sequence of route points, each expressed as continuous coordinates and associated movement conditions such as target altitude and target speed. The server applies a post-processing algorithm to the model output. The server quantizes coordinates to a grid compatible with the navigation capabilities of the moving body, enforces bounds on altitude, and ensures that successive points respect maximum turn angles and climb rates determined by the physical characteristics of the moving body.

The server uses a geospatial algorithm, implemented for example with computational geometry libraries, to verify that each route point lies outside of restricted areas and maintains a minimum separation distance from known obstacles. If the route violates a constraint, the server selectively removes or adjusts route points and, in some embodiments, generates a new prompt sentence indicating the violated constraint and requests a refined route from the generative AI model. By tightly coupling constraint checks with model-driven generation, the server reduces the number of full recomputation cycles and minimizes processor load.

The server converts the validated sequence of route points and movement conditions into a sequence of control commands that the moving body can execute. The server maps each route point and movement condition to a specific low-level control instruction format of the moving body, such as a mission item specifying a target position, an altitude, a speed, and a command type. The server orders the control commands according to the route sequence and stores them in a mission data structure. The server transmits the mission data structure to the moving body using the wireless communication unit.

The moving body receives the control commands and executes them using its onboard flight controller. The flight controller reads signals from the position acquisition device, which may be a satellite positioning receiver, and from inertial sensors such as accelerometers and gyroscopes. The flight controller implements sensor fusion algorithms, such as an extended Kalman filter, to estimate the current position and orientation of the moving body. Using this estimate and the control commands, the flight controller adjusts motor outputs and actuator positions to move the moving body along the specified route.

The server continuously receives position information and state information from the moving body. The state information includes parameters such as battery level, remaining payload, link quality, and health of onboard subsystems. The server integrates these data with updated environmental information obtained from external sources. The server then decides when to generate additional prompt sentences to update or replace the route. For example, when wind speed on a segment exceeds a threshold or when the predicted battery margin falls below a limit, the server generates an additional prompt sentence instructing the generative AI model to compute either a modified route or a retreat route.

The server configures the generative AI model to use specific loss functions and training procedures during a training phase performed prior to deployment. The server (or a separate training system) uses supervised learning and reinforcement learning on training datasets containing historical flight logs, environmental data, and expert-designed or simulation-optimized routes. The server defines a loss function that penalizes excessive route length, high exposure to dangerous environmental conditions, and violations of physical constraints of the moving body. The server also includes regularization terms to improve generalization. During training, the server performs mini-batch gradient descent with back-propagation to update model weights. The server computes gradients of the loss function with respect to the model parameters and adjusts the weights using an optimization algorithm such as an adaptive learning rate method. The server may apply data augmentation procedures, such as perturbing wind profiles, adding synthetic obstacles, or shifting coordinates, to increase robustness of the model.

By designing the neural network architecture and the training process in this manner, the server ensures that the generative AI model outputs routes that are not only geometrically valid but also optimized for safety and efficiency under realistic environmental conditions. This training and architecture configuration improves the internal computational behavior of the model, allowing the server to compute high-quality routes in fewer inference steps and with reduced need for post hoc correction, thereby improving processing speed and reducing computational load.

The server calculates an estimated arrival time by executing a predictive algorithm that uses both the current route information and the dynamic state of the moving body. The server integrates along the route segments using predicted segment times derived from movement conditions, environmental effects, and historical performance data. The server may employ a secondary predictive model, such as a regression model trained on past flights, to correct systematic biases and variability in arrival time estimates. By coupling the estimated arrival time calculation to the same data pipeline as the route computation, the server reduces discrepancies between planned and reported times and enhances the consistency of notifications to the terminal.

The server reduces communication load by transmitting only incremental updates to the route when feasible. For example, when only a subset of downstream route points is modified in response to a change in weather, the server transmits updated control commands only for those affected points. This reduces the size of wireless messages and lowers latency compared to resending an entire mission. By coordinating route generation, validation, and incremental update logic, the server improves overall network efficiency and resilience. The server improves computational efficiency by using indexed data structures and pre-processed spatial layers. The server stores geographic information with spatial indices that allow rapid retrieval of all terrain and obstacle elements intersecting a corridor around the current route. The server stores environmental information in time-indexed structures that enable quick access to relevant time slices for the current or predicted position of the moving body. These data structures reduce the number of database queries and allow the processor to fetch all required features in a small number of operations, thereby improving data throughput for the generative AI model and associated validation modules.

The server uses the generative AI model not as a mere replacement for human planning, but as an integrated computational component that modifies the way the computer system performs route computation. Unlike manual planning or simple rule-based pathfinding, the generative AI model learns non-linear relationships between terrain, weather, and dynamic constraints, and outputs route structures optimized across many criteria simultaneously. The server exploits these capabilities by adaptively shaping prompt sentences and feature sets according to real-time conditions, which results in fewer iterations and more stable convergence of the route planning process. This interaction changes the internal computing process on the server from a static, algorithmic search to a dynamic, model-driven sequence generation with constrained post-processing.

The server thereby achieves technical effects that include an increase in route computation speed for complex environments, reduction in the number of invalid or unsafe candidate routes requiring correction, reduction of wireless communication load through incremental updates, and improvement in the accuracy of estimated arrival times. Because the server integrates route generation, control command conversion, and arrival time prediction into a unified data pipeline, the overall data management within the system is simplified and made more efficient compared to conventional architectures where these components are separated. In another embodiment, the server employs a different neural network architecture for the generative AI model, such as a recurrent network with attention or a graph-based network that processes explicit graph representations of the environment. In yet another embodiment, the server uses a hybrid architecture in which a deterministic shortest-path algorithm initializes a coarse path and the generative AI model refines that path at higher resolution. In all such variations, the server maintains the same general pattern of generating prompt sentences, building structured feature inputs, executing the model, verifying constraints, converting outputs into control commands, and performing dynamic updates based on feedback from the moving body.

In another embodiment, the terminal runs on a different type of client device, such as an embedded controller in a logistics facility or an in-vehicle console. The terminal still transmits delivery request information and receives notification information from the server but may present simplified interfaces or automated workflows. The technical operations on the server side remain focused on internal data processing, model execution, and control command generation, independent of the particular human-facing business workflow. In a further embodiment, the moving body is a ground-based autonomous vehicle or a marine vehicle instead of an aerial vehicle. The server modifies the geographic and environmental feature sets accordingly, for example incorporating road network constraints or water current data, but still uses the same generative AI model framework and control command sequence structure. Because the claimed system is defined in terms of generic moving bodies, position acquisition devices, and control command sequences, these variations fall within the same technical concept.

By configuring the server, terminal, and moving body in this way, the system provides a concrete implementation that directly controls physical equipment and improves the computer's operation when executing route planning and mission control. The server's use of a generative AI model, context-sensitive prompt sentences, specialized data structures, and dynamic constraint checking changes the internal processing of the computing system and yields measurable technical benefits in speed, accuracy, robustness, and communication efficiency.

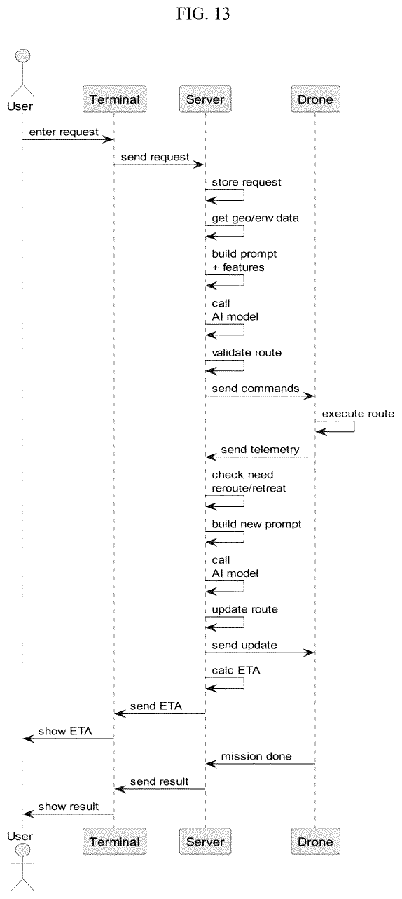

The following describes the processing flow using FIG. 13.

### Step 1:

User operates the terminal to launch a dedicated application and open a delivery request screen. As input, the user provides destination information (for example, an address or coordinates) and package information (for example, weight, size, and special handling requirements) via text fields and selection widgets. The terminal receives these raw inputs from the user interface components and converts them into internal data fields such as normalized strings and numeric values. The terminal outputs a structured delivery request object that encapsulates the destination information and package information in a format suitable for further processing.

### Step 2:

Terminal validates the delivery request object and transmits it to the server. As input, the terminal receives the delivery request object from Step 1. The terminal executes validation logic to check for missing fields, invalid characters, and value ranges (for example, ensuring that weight is within an allowed range), and performs simple geocoding if needed to obtain approximate coordinates from the destination text. The terminal then encodes the validated data into a structured message such as a JSON payload and initiates a secure connection over an information communication network. The terminal outputs an encrypted delivery request message that is sent to the server through a network interface.

### Step 3:

Server receives and stores the delivery request information. As input, the server obtains the encrypted delivery request message from the terminal. The server decrypts the message, parses the structured payload, and verifies the integrity of the data using checks such as schema validation and authentication checks. The server assigns a unique identifier to the request and inserts a record into a storage device, including fields for the request identifier, destination information, package information, and an initial status value. The server outputs a stored delivery request record and a confirmation message back to the terminal.

### Step 4:

Server acquires geographic information and environmental information relevant to the request. As input, the server uses the destination information and, optionally, an origin position for the moving body. The server queries a geographic information store to retrieve map data, terrain elevation data, building polygons, and any precomputed route graphs along a corridor between origin and destination. The server also queries one or more environmental information sources to obtain weather data, airspace restrictions, obstacle locations, and traffic data valid for the time window of the expected movement. The server performs data processing operations such as spatial filtering, coordinate transformation, and time alignment so that only data within a specific geographic bounding box and time interval are selected. The server outputs a set of structured geographic features and environmental features associated with the delivery request.

### Step 5:

Server constructs a prompt sentence and model input features for the generative AI model. As input, the server receives the structured geographic features, environmental features, and the delivery request record. The server composes a natural-language prompt sentence describing the routing task and constraints. For example, the server generates: “Using current weather, terrain elevation, and no-fly zones, generate an optimal aerial delivery route from the origin coordinates to the destination coordinates. Output a sequence of waypoints with latitude, longitude, and altitude, and output a recommended speed for each segment.” The server tokenizes the prompt sentence into tokens and maps each token to an embedding vector. In parallel, the server converts geographic and environmental features into numeric tensors, such as elevation grids, wind vector fields, and binary masks for restricted areas. The server normalizes these tensors (for example, scaling elevation values and wind speeds) and aligns them to a common coordinate system. The server outputs a combined model input that includes token embeddings and structured feature tensors.

### Step 6:

Server executes the generative AI model to generate candidate route information. As input, the server supplies the combined model input from Step 5 to the generative AI model stored in memory. The server invokes forward inference on the model, which processes the embeddings and feature tensors through multiple neural network layers, including attention layers and non-linear transformations. The model performs internal data operations such as matrix multiplications, activation function evaluations, and attention-weight computations to infer relationships between terrain, weather, and route structure. The server obtains from the model an output sequence representing route points and associated movement conditions, such as coordinates, target altitudes, and recommended speeds. The server outputs raw route information generated by the generative AI model.

### Step 7:

Server validates and refines the route information. As input, the server receives the raw route information from Step 6 and the geographic and environmental features from Step 4. The server applies geospatial algorithms to check each route point against restricted areas, obstacle locations, and allowed altitude ranges. The server calculates distances between route points and known obstacles, checks whether route segments intersect any restricted polygon, and ensures adherence to maximum climb rates and turn angles defined for the moving body. When a constraint violation is detected, the server adjusts affected points by shifting them along allowed corridors or by inserting intermediate points, and, if necessary, regenerates a prompt sentence to request a corrected route from the generative AI model. The server outputs a validated and refined sequence of route points and movement conditions.

Server converts the validated route into a sequence of control commands for the moving body. As input, the server receives the validated and refined route points and movement conditions. The server maps each route point to a control command specifying a target position, target altitude, and required speed or other control parameters. The server orders these commands in the sequence corresponding to the planned traversal of the route. During this processing, the server converts geographic coordinates into the specific coordinate reference or format required by the moving body's control system. The server encapsulates the control commands into a mission data structure that may include metadata such as mission identifier and execution flags. The server outputs the mission data structure representing the sequence of control commands.

### Step 9:

Server transmits the control commands to the moving body and initiates mission execution. As input, the server uses the mission data structure from Step 8. The server establishes or maintains a wireless communication session with the moving body, fragments the mission data into packets suitable for the wireless link, and transmits the packets through the wireless communication unit. The server waits for acknowledgment messages from the moving body and retransmits specific packets if acknowledgments are not received within a timeout. The server updates the delivery request record to indicate that the mission has been uploaded and marks the status as active. The server outputs a mission upload confirmation and a state indicating that the moving body can commence route execution.

### Step 10:

Moving body executes the mission and sends telemetry, while the server monitors and logs the state. As input, the moving body receives the sequence of control commands. The moving body feeds these commands into its flight controller, which reads position data from the position acquisition device and sensor data from onboard sensors. The flight controller performs sensor fusion and control loop computations to generate actuator signals that cause the moving body to follow the specified route. In parallel, the moving body sends periodic telemetry messages to the server, including position information, velocity, battery level, and system status. The server receives these telemetry messages, timestamps them, and stores them in a log database. The server outputs an updated internal representation of the moving body's state along the route.

### Step 11:

Server performs dynamic route monitoring and determines whether recalculation or retreat is required. As input, the server takes the telemetry data from Step 10 and updated environmental information from external sources. The server computes deviations between the actual path and the planned route, calculates safety margins such as remaining battery, distance to obstacles, and margins to restricted areas, and compares these metrics with predetermined thresholds. When the server detects that a threshold is violated or is likely to be violated (for example, battery becoming insufficient to reach the destination under current wind conditions), the server identifies the need for a route update or a retreat. The server outputs a decision indicating either “continue with current route,” “recalculate route,” or “calculate retreat route,” together with the current state snapshot of the moving body.

### Step 12:

Server generates an additional prompt sentence and recalculates or computes a retreat route using the generative AI model. As input, the server uses the decision from Step 11, the current position and state of the moving body, and the most recent geographic and environmental features. If a new route is required, the server constructs a prompt sentence such as: “From the current drone position, generate a safe and efficient diversion route to the original destination, avoiding new no-fly zones and regions with wind speeds above 15 meters per second.” If a retreat route is required, the server constructs a prompt sentence such as: “Given the current drone position and known safe landing locations, determine the safest immediate landing location and generate a retreat route to that location that minimizes exposure to strong winds and high obstacle density.” The server tokenizes the new prompt sentence, regenerates feature tensors centered around the new current position, and feeds the combined input into the generative AI model. The server receives updated route information, validates it as in Step 7, converts it into control commands as in Step 8, and transmits the incremental updates to the moving body. The server outputs an updated mission or retreat mission that reflects the recalculated route.

### Step 13:

Server computes an estimated arrival time and notifies the terminal. As input, the server uses the current route information (either original or updated), telemetry data indicating the current position and velocity of the moving body, and environmental parameters such as wind and traffic. The server divides the route into segments and estimates the time to traverse each segment based on movement conditions and environmental effects, summing these times to obtain a total remaining travel time. The server may adjust this estimate using a predictive model trained on historical missions. The server then computes an estimated arrival time by adding the remaining travel time to the current time. The server constructs a notification payload containing the estimated arrival time, current position, and route status. The server transmits this payload to the terminal through the network. The terminal receives the payload, parses the data, and updates its display to show the user the estimated arrival time and current status of the moving body. The server outputs consistent, dynamically updated arrival predictions presented to the user via the terminal.

### Step 14:

Server processes completion or termination of the mission and records final results. As input, the server receives a completion signal from the moving body, such as a status message indicating that the final route point has been reached and the payload has been handled, or a termination signal indicating that a retreat has been executed. The server validates the final status, cross-checking the moving body's last reported position and state. The server updates the delivery request record with the final outcome, including completion time, total mission duration, and summary statistics such as total distance flown and number of route updates. The server generates a final notification to the terminal, informing the user of successful completion or of the nature of any retreat. The terminal receives and displays this final notification. The server outputs a completed log of the mission that can be used for analysis, retraining of the generative AI model, and system diagnostics.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional route guidance and autonomous transport systems, routing logic is typically implemented as a fixed set of algorithms that operate on static map data and simple sensor inputs. Such systems exhibit several technical limitations.

First, conventional processors select routes based on limited parameters and do not dynamically integrate heterogeneous, real-time operational context such as high-granularity environmental sensing data, vehicle state data, and complex constraint sets into a unified decision process. As a result, the processor often computes sub-optimal or unsafe routes when weather changes, obstacles appear, or energy constraints tighten, thereby degrading the reliability and efficiency of the overall computing system.

Second, conventional systems that attempt to incorporate advanced machine learning models for route optimization generally hard-code model interfaces and feature sets. They do not employ a flexible control mechanism that formulates a machine-interpretable task description, such as a structured natural language prompt, based on current operational context. Consequently, the processor cannot fully exploit the reasoning capability of a generative AI model and cannot adapt its behavior to unforeseen conditions or new constraint types without substantial re-engineering of software components.

Third, existing notification subsystems often estimate arrival times using simple linear calculations that do not leverage historical operation data or rich telemetry streams. This leads to inaccurate estimated time of arrival (ETA) values, inconsistent user interfaces, and inefficient utilization of network resources, because notifications are either too frequent or too sparse and are not tailored to real-time transport conditions.

Fourth, conventional systems treat user-related information merely as passive parameters, and do not use advanced emotion estimation techniques to adjust computational priorities within the routing and scheduling pipeline. As a result, the processor fails to exploit available user-state information to optimize resource allocation, and the computing system cannot dynamically adjust transport priority, notification policies, or control parameters in a way that improves perceived responsiveness while preserving safety and efficiency.

Fifth, in the presence of hazards such as severe weather or unexpected obstacles, many systems rely on fixed fallback rules. These rules do not flexibly recompute retreat routes using the same rich context used for forward routing and do not leverage generative models to explore alternative retreat strategies. Therefore, the processor cannot consistently compute context-appropriate safe retreat routes, which reduces the robustness and safety of the autonomous transport platform.

Accordingly, there is a need for an improved computer-implemented system in which a processor: (i) acquires and fuses current position, geographic information, environmental sensing data, and vehicle state data into structured operational context; (ii) automatically generates and supplies context-dependent prompt sentences to a generative AI model to obtain route candidates and control policies; (iii) validates and refines routes using algorithmic verification to ensure safety and feasibility; (iv) predicts ETA using real-time telemetry and historical operation data; (v) generates and transmits notification information based on these predictions; and (vi) estimates user emotion from multimodal user-state information and uses the estimated emotion to modify route information or transport priority. By improving how the processor orchestrates these interactions, the invention aims to achieve a technical improvement in the functioning of computer-based routing, control, and notification subsystems, rather than merely automating a human business process.

The specific processing by the specific processing unit 290 of the data processing device 12 in Application Example 2 is realized by the following means.

The present invention provides a server comprising a processor configured to acquire a current position of a mobile object or a user by using a position acquisition device, to obtain geographic information and route constraint information from a geographic information storage apparatus via a communication network, and to generate operation status information including at least weather information, traffic information, remaining power information, and obstacle information based on data acquired from an environmental sensing device and the mobile object. This enables the server to construct a unified, machine-processable representation of dynamic operational context that can be used as input for subsequent route generation and control processing.

The present invention further provides the server in which the processor is configured to generate a prompt sentence to be input to a generative information processing model on the basis of the operation status information and the geographic information, the prompt sentence instructing calculation of at least one route candidate and a route control policy to a destination, and to input the prompt sentence to the generative information processing model. This enables the processor to externalize the routing problem as a structured task description, allowing the generative AI model to perform high-level reasoning over rich context without requiring rigid, model-specific feature engineering.

The present invention further provides the server in which the processor is configured to obtain the route candidate output from the generative information processing model, to verify or correct the route candidate by using a route search algorithm implemented on the server, and to generate route information that satisfies pre-defined safety constraints and feasibility conditions. This enables the system to combine the expressive planning capability of the generative AI model with deterministic algorithmic verification, thereby improving reliability and safety of the computed route and preventing unsafe or infeasible paths from being executed.

The present invention further provides the server in which the processor is configured to generate a control command sequence for an unmanned mobile object or a vehicle on the basis of the route information, and to transmit the control command sequence to the unmanned mobile object or the vehicle so as to cause the unmanned mobile object or the vehicle to perform autonomous movement or autonomous transport, and to acquire position information and operation information transmitted from the unmanned mobile object or the vehicle. This enables the server to directly translate high-level route information into low-level control signals, to maintain a closed feedback loop with the mobile object, and to adapt control in real time based on telemetry.

The present invention further provides the server in which the processor is configured to predict an estimated time of arrival on the basis of operation information including at least travel speed, remaining distance, and wind speed information, and to generate notification information according to the estimated time of arrival and an operation status, and to transmit the notification information to a user information processing apparatus. This enables the system to improve ETA accuracy and to adjust notification timing and content in response to real-time transport conditions, thereby enhancing the technical performance of the notification subsystem with respect to timeliness and network efficiency.

The present invention further provides the server in which the processor is configured to estimate an emotion of the user from information indicating an emotional state of the user by using an emotion estimation model, including a generative information processing model that responds to a prompt sentence describing the user-state information, and to generate control information for changing at least one of the route information and a transport priority in accordance with the estimated emotion. This enables the server to modify internal scheduling and routing decisions based on user-state-dependent control parameters, such that computational resources and transport capacity are dynamically allocated in a manner that improves overall system responsiveness while maintaining safety constraints.

The present invention further provides the server in which the processor is configured to analyze data from the environmental sensing device and an obstacle detection device, to determine that a predetermined safety condition is not satisfied, to generate a prompt sentence for the generative information processing model to obtain a retreat route candidate to a safe retreat point, to obtain the retreat route candidate from the generative information processing model, to verify the retreat route candidate by using the route search algorithm, and to generate a retreat control command sequence based on a verified retreat route. This enables the system to compute and execute context-appropriate safe retreat routes in hazardous conditions, thereby improving the robustness and fault tolerance of the autonomous transport platform at the level of computer-implemented routing and control logic.

The term “processor” refers to a hardware computing element, such as a central processing unit or a graphics processing unit, and/or a combination of such elements executing machine-readable instructions to perform arithmetic, logical, control, and input/output operations that implement the functions described in the claims.

The term “system” refers to an integrated combination of hardware components and software components, including at least a processor, memory, communication interfaces, and external devices, that cooperate to execute the claimed functions.

The term “mobile object” refers to any moveable machine or device capable of changing its position under its own power or external control, including but not limited to an unmanned aerial vehicle, an unmanned ground vehicle, an autonomous robot, or a powered vehicle.

The term “user” refers to a human operator or human beneficiary that issues requests to the system, receives information from the system, or is associated with transport services performed by the system.

The term “position acquisition device” refers to any hardware and software arrangement configured to determine geographic location, including but not limited to a satellite positioning sensor, a terrestrial positioning sensor, an inertial navigation sensor, or a combination thereof.

The term “current position” refers to geographic location information of an entity, such as the mobile object or the user, expressed in a coordinate system, for example latitude and longitude and optionally altitude.

The term “communication network” refers to any wired or wireless data communication infrastructure, including but not limited to local area networks, wide area networks, cellular networks, and the global packet-switched network.

The term “geographic information storage apparatus” refers to any storage system that stores digital geographic data, such as map data, road network data, airspace data, or terrain data, and that is accessible to the processor through the communication network.

The term “geographic information” refers to digital data that represents spatial features of an environment, including but not limited to coordinates of locations, shapes of areas, paths, obstacles, and annotations such as speed limits or altitude limits.

The term “route constraint information” refers to data that defines limitations, rules, or preferences for path selection, including but not limited to prohibited regions, restricted corridors, preferred paths, speed restrictions, altitude restrictions, and temporal availability constraints.

The term “environmental sensing device” refers to a sensor or a sensor arrangement configured to detect physical environmental conditions, including but not limited to temperature sensors, wind sensors, rain sensors, optical cameras, range sensors, and combinations thereof.

The term “operation status information” refers to structured data that describes current operational conditions of the system and the mobile object, including at least weather information, traffic information, remaining power information, and obstacle information.

The term “weather information” refers to data representing environmental meteorological conditions that affect movement of the mobile object, including but not limited to wind speed, wind direction, precipitation, temperature, and visibility.

The term “traffic information” refers to data representing dynamic occupancy or load of a transportation environment, including but not limited to presence and density of other vehicles, air traffic, road congestion levels, or similar movement-related conditions.

The term “remaining power information” refers to data describing the current energy state of a power source associated with the mobile object, such as battery charge level, estimated remaining operating time, or fuel level.

The term “obstacle information” refers to data indicating the presence, location, and characteristics of physical objects that may interfere with the movement of the mobile object, including both static obstacles such as buildings and dynamic obstacles such as other vehicles.

The term “generative information processing model” refers to a machine-implemented model, such as a generative AI model, trained to produce output data in response to input data, including but not limited to natural language models, sequence-to-sequence models, or similar models capable of generating route candidates or control policies.

The term “prompt sentence” refers to a machine-interpretable input expression, typically expressed in natural language and optionally including structured data, that specifies a task or query for the generative information processing model to execute.

The term “route candidate” refers to one or more proposed paths or trajectories from a start position to a destination position, generated by the generative information processing model or by other algorithms, prior to verification or correction.

The term “route control policy” refers to a set of instructions, parameters, or rules describing how the mobile object should traverse a route candidate, including but not limited to speed profiles, altitude profiles, or priority handling rules.

The term “route search algorithm” refers to a computational procedure that operates on a representation of a spatial environment, such as a graph, to determine or evaluate paths according to one or more cost criteria, and may include algorithms such as shortest path algorithms or heuristic search algorithms.

The term “route information” refers to a verified or corrected representation of a movement path that satisfies predetermined safety and feasibility conditions, including an ordered list of waypoints and associated control parameters.

The term “control command sequence” refers to an ordered set of control directives that are interpretable by a controller of a mobile object or vehicle and that cause the mobile object or vehicle to perform operations, such as takeoff, movement, turning, altitude changes, or landing.

The term “unmanned mobile object” refers to a mobile object that operates without an onboard human operator, including but not limited to unmanned aerial vehicles, unmanned ground vehicles, or autonomous robots.

The term “vehicle” refers to a transport apparatus that is configured to move people or goods, including but not limited to ground vehicles, watercraft, and aircraft, whether manned or unmanned.

The term “autonomous movement” refers to movement of a mobile object or vehicle that is controlled by onboard or remote computing systems without continuous manual control by a human operator.

The term “autonomous transport” refers to a process in which a mobile object or vehicle autonomously moves a payload, such as goods or items, between locations based on computer-generated control commands.

The term “position information” refers to data representing a location of the mobile object or the vehicle over time, typically including coordinates and optionally altitude and orientation.

The term “operation information” refers to data describing dynamic state of the mobile object or the vehicle, such as speed, acceleration, heading, battery state, and status of actuators or sensors.

The term “estimated time of arrival” refers to a predicted temporal value indicating an expected time at which the mobile object or vehicle will reach a specified destination.

The term “notification information” refers to content generated by the processor for delivery to a user information processing apparatus, indicating at least status, estimated time of arrival, delay, or hazard information relating to a movement or transport operation.

The term “user information processing apparatus” refers to a computing device operated by or associated with a user, such as a terminal, mobile communication device, or client computer, that can receive and present notification information.

The term “emotion estimation model” refers to a machine-implemented model trained to infer emotional states from input data, including but not limited to images, sounds, and texts, and to output an emotion label or score.

The term “information indicating an emotional state of the user” refers to data from which an emotion of the user can be inferred, including but not limited to facial images, voice signals, written messages, or postings in information dissemination services.

The term “emotion” refers to a classification of a psychological state of the user, such as joy, sadness, anger, or neutral, as inferred by the emotion estimation model.

The term “control information” refers to data that modifies or defines control behavior of the system, such as adjustments to route information, scheduling priorities, or notification policies.

The term “transport priority” refers to a relative ranking or weighting used by the processor to order, accelerate, delay, or otherwise differentiate transport operations for multiple requests.

The term “image information” refers to digital data representing visual scenes, such as still images or video frames, that may include a user's facial expression or surrounding environment.

The term “sound information” refers to digital audio data representing acoustic signals, including a user's speech, tone of voice, or environmental sounds.

The term “communication text information” refers to textual content exchanged through communication channels, such as chat messages, emails, or short text messages.

The term “posting information to an information dissemination service” refers to digital content, such as text, images, or multimedia, that a user submits to a service that distributes or publishes information to other users, for example a social networking or messaging service.

The term “notification frequency” refers to a rate or pattern at which notification information is generated and transmitted from the server to the user information processing apparatus.

The term “environmental sensing device” refers to a sensor device or arrangement that measures environmental conditions external to the mobile object or vehicle, including but not limited to weather, lighting, and surrounding objects.

The term “obstacle detection device” refers to a sensing apparatus configured to detect and locate potential obstacles in the movement path of the mobile object or vehicle, such as range finders, cameras, or combined sensor systems.

The term “predetermined safety condition” refers to a condition defined by one or more thresholds or rules related to operational risk, such as maximum allowable wind speed, minimum remaining power, or minimum separation distance from obstacles.

The term “safe retreat point” refers to a designated location or area that meets safety criteria for stopping, landing, or otherwise halting the operation of the mobile object or vehicle in response to a hazard.

The term “retreat route candidate” refers to a proposed path from a current position of the mobile object or vehicle to a safe retreat point, generated before verification by the route search algorithm.

The term “retreat control command sequence” refers to a control command sequence that instructs the mobile object or vehicle to follow a retreat route to a safe retreat point in response to a detected unsafe condition.

In one embodiment, a server provides a computer-implemented routing and control platform that cooperates with at least one terminal and at least one mobile object, such as an unmanned aerial vehicle or autonomous ground vehicle. The server includes at least one processor, a memory storing program instructions and trained machine-learning models, and communication interfaces for exchanging data with position acquisition devices, environmental sensing devices, terminals, and mobile objects over a communication network. Server uses a position acquisition device, such as a satellite positioning module or a terrestrial positioning module, to obtain a current position of the mobile object or a user. Server stores position data in a geospatial database, such as a relational database extended with spatial indexing functionality. Server further accesses a geographic information storage apparatus, such as a remote map database accessible via a web service, to download digital geographic information and route constraint information. The geographic information includes nodes, edges, and polygonal areas representing routes, obstacles, and no-movement zones. The route constraint information includes, for example, altitude limits, maximum speed limits, and time-dependent access restrictions.

Server uses an environmental sensing device and an obstacle detection device to obtain weather information, traffic information, remaining power information, and obstacle information. The environmental sensing device includes sensors such as an anemometer, a rain sensor, and a light sensor. The obstacle detection device includes at least one optical sensor and optionally a distance sensor. Server receives raw sensor outputs as time-stamped records, and server aggregates them into structured operation status information. In one embodiment, server maintains operation status information as records that include fields for sensor identifier, geographic coordinates, measurement type, and numeric measurement values.

Server generates operation status information by fusing data from multiple sources. In one embodiment, server performs temporal alignment by interpolating sensor readings to a common time grid and performs spatial alignment by mapping each reading to the nearest node or segment in the geographic graph. Server uses this fusion to generate derived features such as average wind vector along each candidate edge, expected energy consumption, and probability of encountering obstacles. This structured aggregation improves the quality of input to subsequent algorithms, thereby increasing route calculation accuracy and reducing unnecessary re-planning.

Server uses a generative AI model as a generative information processing model. In one embodiment, the generative AI model is a transformer-based neural network with multiple self-attention layers, trained on a corpus that includes textual descriptions of routing problems and structured examples of routes represented as sequences of waypoints. Server stores model parameters in a model storage area of the memory and executes inference on a hardware accelerator, such as a graphics processing unit. The transformer network uses positional encodings and multi-head attention to relate elements of the prompt sentence and can output structured sequences describing route candidates and route control policies. Server generates a prompt sentence for the generative AI model by encoding operation status information and geographic information into a natural language description. In one embodiment, server formats the prompt sentence as a textual instruction that explicitly specifies the current position, destination position, weather information, constraints, and desired output format. For example, server generates a prompt sentence such as: “You are a routing engine for an autonomous aerial vehicle. Current position: latitude 35.681236, longitude 139.767125. Destination: latitude 35.658034, longitude 139.701636. Wind speed: 8 meters per second from the west. Battery level: 70 percent. No-fly zones are defined by the following polygons (coordinates omitted). Calculate an optimal safe route as an ordered list of waypoints with latitude, longitude, and altitude, avoiding no-fly zones and minimizing total travel time. Output the waypoints in order, and do not include any additional explanation.”

Server then transmits this prompt sentence to the generative AI model. The generative AI model parses the textual instruction and internally maps the content to a sequence of embeddings. The model processes the embeddings through attention layers and feedforward layers, and produces a token sequence that encodes a set of candidate waypoints and route control policies. Because server constrains the output format in the prompt sentence, server can reliably parse the output into a programmatic representation, such as a list of waypoint objects with associated attributes.

Server obtains the route candidate from the generative AI model and performs algorithmic verification and correction. In one embodiment, server converts the route candidate into a path in a graph representation of the environment, where nodes correspond to waypoints and edges correspond to traversable segments. Server then executes a route search algorithm, such as a shortest-path algorithm or a heuristic search algorithm, to check whether each segment of the route candidate respects route constraint information, including no-movement zones, altitude limits, and minimum clearance from obstacles. When server detects a violation, server replaces the offending segment with an alternative segment determined by the route search algorithm, minimizing deviation from the original route and controlling additional energy cost.

Server calculates route information after verification and correction. Route information includes at least an ordered sequence of nodes, each node carrying fields for latitude, longitude, altitude, allowed speed, and expected traversal time. Server also attaches metadata, such as risk scores and safety margins, to each segment. This explicit structure enables server to perform subsequent ETA predictions and safety checks efficiently by traversing the route information and computing cumulative costs.

Server generates a control command sequence for the mobile object based on the route information. In one embodiment, server converts each waypoint into a set of low-level commands interpretable by an onboard controller of the mobile object. For example, server assembles commands specifying a target coordinate, target altitude, and target speed, and arranges them into a sequence that includes takeoff, cruise, descent, and landing phases. Server then transmits the control command sequence to the mobile object through a wireless communication interface using a transport protocol designed for control messages. Terminal receives the control command sequence and forwards it to a control unit of the mobile object. Terminal can be implemented as an onboard computing device that decodes command messages and interacts with actuators and local sensors. Terminal continuously monitors sensors such as inertial measurement units, position sensors, and the environmental sensing device, and terminal adjusts actuator signals to maintain the commanded path within predefined tolerances. This feedback control contributes to reducing tracking errors and ensures that the mobile object follows the verified route information.

Server receives position information and operation information transmitted from the mobile object during autonomous movement or autonomous transport. In one embodiment, the mobile object periodically sends telemetry packets that include current coordinates, speed, heading, altitude, energy state, and diagnostic flags. Server stores these telemetry packets as time-series data and uses them to update operation status information. Server further uses these telemetry data as input features to an ETA prediction model.

Server implements the ETA prediction model as a supervised machine-learning model that may be distinct from the generative AI model. In one embodiment, server uses a recurrent neural network or a feedforward network to map a feature vector to a remaining travel time. The feature vector includes, for example, the remaining distance along the verified route, the average speed over recent intervals, current wind speed and direction, altitude profile, and remaining power. Server trains this model offline using historical telemetry and ground-truth arrival times, minimizing a loss function such as mean squared error. During operation, server performs inference on this model in real time to output an updated estimated time of arrival as a scalar value.

Server generates notification information according to the estimated time of arrival and the current operation status. Notification information includes at least the estimated remaining time, any detected delays, and explanations when a retreat route is triggered. Server transmits notification information to a user information processing apparatus, such as a terminal operated by the user, using appropriate protocols such as push messaging or text messaging. Because server bases the notifications on model-based ETA predictions that consider real-time telemetry and environmental conditions, the notifications provide improved accuracy and timeliness compared to simple linear estimates, thereby reducing unnecessary user-driven status requests and saving communication resources.

Server further estimates an emotion of the user by using an emotion estimation model. In one embodiment, server receives image information and sound information from terminal, where terminal has captured a facial image and a voice sample of the user. Server pre-processes the facial image by detecting facial landmarks and normalizing the image, and server pre-processes the voice sample by extracting acoustic features such as pitch contours and spectral coefficients. Server concatenates these features into a multimodal feature vector. Server implements the emotion estimation model as a neural network architecture that includes a convolutional sub-network for visual features, a recurrent or convolutional sub-network for audio features, and a fusion layer combining the outputs of these sub-networks. Server trains this model on labeled datasets where emotional states are annotated. During execution, server feeds the feature vector through the network to obtain a set of emotion scores for categories such as joy, sadness, anger, and neutral. Server selects the emotion with the highest score as the estimated user emotion and stores the result in an emotion record associated with the user.

In another embodiment, server estimates the user emotion from communication text information or posting information to an information dissemination service. Server receives text data from terminal or from an external service through an application programming interface. Server then constructs a prompt sentence directed to the generative AI model, for example:
“Analyze the following user message and classify the dominant emotion as joy, sadness, anger, or neutral. Message: ‘I can't wait for my new gadget to arrive!’ Respond only with one word: joy, sadness, anger, or neutral.”

Server transmits this prompt sentence to the generative AI model, which has been fine-tuned to perform emotion classification tasks. Server parses the single-word response and uses it as the estimated emotion. Because server uses a prompt sentence that constrains the output format and the response content, server can reliably interpret the model's decision in a deterministic manner.

Server generates control information for changing at least one of the route information and the transport priority in accordance with the estimated emotion. In one embodiment, server defines a mapping from emotion categories to numerical priority adjustments. For example, server assigns a positive priority shift to joy and a neutral shift to other emotions. Server then updates an internal priority queue of active transport requests. When server assigns resources, such as mobile objects and communication bandwidth, server uses the updated priorities to determine which routes are scheduled earlier or which routes are allowed to use more conservative safety margins. By adjusting these control parameters programmatically, server improves responsiveness for users with certain emotional states while preserving base safety requirements.

Server also uses the generative AI model to recommend retreat routes under unsafe conditions. When server analyzes data from the environmental sensing device and the obstacle detection device and determines that a predetermined safety condition is not satisfied, server assembles a prompt sentence that describes the current position, nearby safe retreat points, and hazardous conditions. For example:
“An autonomous aerial vehicle is currently at latitude 35.670000, longitude 139.750000, altitude 100 meters. Strong wind exceeding 15 meters per second and heavy rain have been detected ahead on the planned route. Safe landing points are available at coordinates A, B, and C. Propose a safe retreat route from the current position to one of the safe landing points, avoiding high-rise areas and minimizing risk. Output an ordered list of retreat waypoints with latitude, longitude, and altitude, and specify which landing point is selected.”

Server sends this prompt sentence to the generative AI model. The model responds with a retreat route candidate. Server then uses the route search algorithm in the same manner as for forward routes to verify that the retreat route candidate satisfies safety constraints. If verification succeeds, server generates a retreat control command sequence and transmits it to the mobile object. In this way, server uses the generative AI model not merely to automate human thought but to dynamically explore non-obvious retreat strategies in complex constraint spaces, while retaining algorithmic enforcement of safety rules.

Terminal displays notification information on a user interface and accepts user input. In one embodiment, terminal runs an application that subscribes to server updates, presents estimated times of arrival, and displays a map with the current position of the mobile object and the verified route. Terminal receives user acknowledgments, such as delivery confirmations or cancellation requests, and transmits such user input to server. This interaction allows server to update transport status and to adjust scheduling as needed. User uses terminal to initiate transport requests, review notification information, and optionally provide consent for the use of emotional-state information. User may select privacy settings controlling whether image information, sound information, or text information is used for emotion estimation. By explicitly involving the user in configuration, the system can be deployed in environments with varying regulatory and user-expectation requirements.

The described architecture provides several technical effects. Because server fuses high-granularity sensing data and geographic data into structured operation status information, server can compute more accurate and safer routes than systems that treat sensor readings in an ad hoc manner. Because server uses generative AI models via well-defined prompt sentences, server can adapt to new constraint types or operating conditions without re-implementing specialized feature extractors or handcrafted rules, thereby reducing development effort and improving maintainability. At the same time, because server always subjects the model's route candidates to deterministic verification by route search algorithms, server avoids uncontrolled behavior and enforces safety and feasibility.

Furthermore, because server implements ETA prediction using trained models on telemetry history, ETA accuracy improves over simple rule-based calculations. This improvement reduces unnecessary communication by avoiding repeated user queries and redundant notifications. The system can further reduce communication load by adjusting notification frequency based on both ETA uncertainty and user emotion, sending more frequent updates when uncertainty or user sensitivity is high and fewer updates when conditions are stable. In addition, because server uses structured data representations, such as graphs with precomputed weights for environmental risk and energy consumption, the computational complexity of route verification and correction is reduced. Server can reuse graph structures across multiple requests and can cache route fragments for recurrent origin-destination pairs. These design choices contribute to improvements in processing speed and scalability when the system must handle many simultaneous transport operations.

Alternative embodiments are possible. In one embodiment, server executes the generative AI model and the emotion estimation model on separate processing units and uses an inter-process communication mechanism to coordinate their outputs. In another embodiment, server integrates both capabilities into a single multi-task model that receives prompt sentences specifying routing tasks or emotion classification tasks. In yet another embodiment, terminal performs part of the emotion estimation locally, for example by executing a lightweight convolutional network for facial expression recognition, and transmits only intermediate features or emotion labels to server to reduce bandwidth usage.

Server, terminal, and user interactions as described can be implemented with various hardware and software platforms. Server can run on a cloud computing infrastructure or on dedicated on-premise hardware; terminal can be implemented on a mobile communication device or on an onboard computing platform of the mobile object; user can operate a handheld device or a desktop client. In each case, the essential operations remain: server constructs operation status information, generates and submits prompt sentences to a generative AI model, validates model outputs with route search algorithms, generates control command sequences for mobile objects, predicts estimated times of arrival, provides notification information, and adjusts route information or transport priority based on estimated user emotions.

By integrating these operations into a coherent system, the invention improves the functioning of the underlying computer technology. The combination of generative AI-based planning, algorithmic verification, model-based ETA prediction, and emotion-aware priority control provides a technical solution that enhances accuracy, safety, and efficiency in controlling real-world mobile objects, and does so in a manner that is not achievable by simply automating human decision-making with generic computer tools.

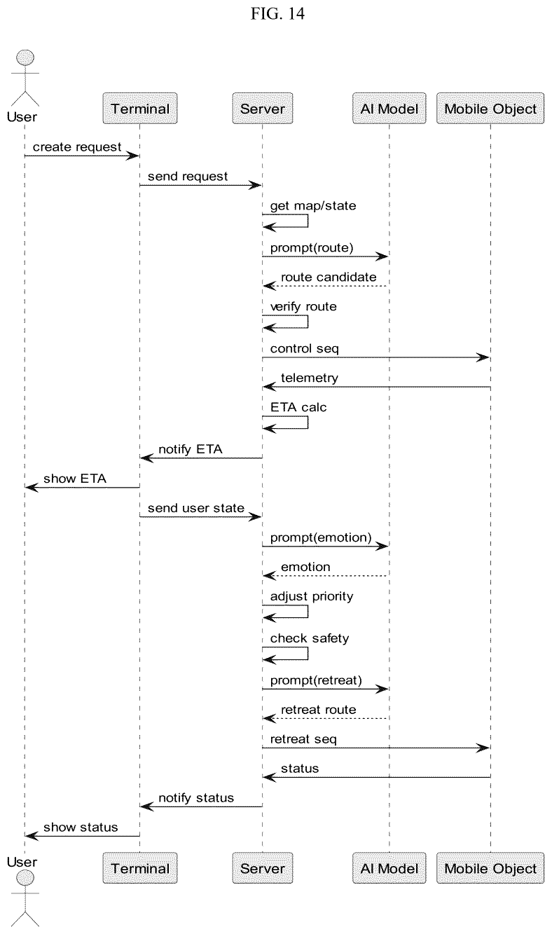

The following describes the processing flow using FIG. 14.

### Step 1:

User operates the terminal to create a transport request.

User inputs item information, destination information, and optional preferred delivery parameters into a graphical user interface of the terminal. As input, the terminal receives item identifiers, quantities, a textual address, and user identifiers. The terminal performs validation of mandatory fields, converts the textual address into geographic coordinates using a map software development kit, and assembles a structured request record. As output, the terminal generates a request message that includes user ID, destination coordinates, item list, and a timestamp, and transmits this message to the server via a network protocol.

### Step 2:

Server receives and registers the transport request.

Server accepts the incoming request message as input, parses the structured fields, and checks consistency and completeness of the data. Server performs data processing by mapping the request parameters into database records, including an order record and a destination record associated with the user. As output, server stores the registered request in persistent storage with an initial status and generates an internal identifier that will be used to track subsequent processing.

### Step 3:

Server acquires geographic information and route constraint information.

Server uses the destination coordinates and configured base locations as input to a geographic information storage apparatus. Server calls a map service interface to obtain a digital representation of the environment, including nodes, edges, and area polygons, and also obtains route constraint information such as no-movement zones and altitude limits. Server processes the downloaded data by constructing a graph structure in memory, assigning weights to edges and flags to restricted regions. As output, server produces a geographic context object that encapsulates the map graph and constraint metadata for the requested route.

### Step 4:

Server collects current position and operational state of the mobile object.

Server uses a position acquisition device and telemetry messages from the mobile object as input. The telemetry includes current coordinates, speed, heading, altitude, and remaining power level. Server processes these data by updating the current node or edge in the map graph and computing derived metrics such as remaining energy margin. As output, server generates a state descriptor that represents the current position of the mobile object, its dynamic state, and basic feasibility of completing the requested route.

### Step 5:

Server aggregates environmental sensing data and obstacle information into operation status information.

Server receives environmental sensor readings and obstacle detections as input, including wind speed, precipitation intensity, visibility indicators, and obstacle positions. Server time-aligns these readings with the current time and space-aligns them to elements of the map graph. Server performs data fusion by computing averaged values per segment, estimating risk scores, and calculating expected additional energy consumption. As output, server forms structured operation status information that contains weather information, traffic information if available, remaining power information, and obstacle information, all referenced to specific route segments.

### Step 6:

Server generates a prompt sentence for the generative AI model.

Server takes as input the state descriptor, the geographic context object, and the operation status information. Server executes a formatting procedure that converts these structured data into a descriptive natural language instruction. During this data processing, server selects relevant parameters, converts numeric coordinates and constraints into text, and embeds an explicit output format specification. As output, server produces a prompt sentence such as: “You are a routing engine for an autonomous vehicle. Current position: latitude 35.681236, longitude 139.767125. Destination: latitude 35.658034, longitude 139.701636. Wind speed is 8 meters per second from the west. Battery level is 70 percent. Certain regions are prohibited and must be avoided. Calculate an optimal safe route as an ordered list of waypoints with latitude, longitude, and altitude, minimizing travel time while respecting constraints. Output only the waypoint list.”

### Step 7:

Server submits the prompt sentence to the generative AI model and obtains a route candidate. Server uses the prompt sentence as input to the generative AI model hosted on a computing platform. Server invokes a model inference interface, which internally converts the prompt text into token embeddings and applies transformer layers to generate output tokens. From the server's perspective, the data processing consists of sending the prompt, receiving an output text, and parsing the output according to the specified format. As output, server extracts a sequence of waypoints and control hints from the model's response, assembling them into a candidate route data structure.

Server verifies and corrects the route candidate using a route search algorithm. Server inputs the candidate route and the geographic context object into a route search module. Server maps candidate waypoints onto nodes and edges of the map graph and checks for intersections with prohibited regions and constraint violations. Server performs data processing by running a pathfinding algorithm over the graph to repair or replace invalid segments, computing edge costs based on distance, environmental risk, and energy consumption. As output, server generates verified route information comprising a consistent, constraint-compliant sequence of waypoints and associated traversal parameters.

### Step 9:

Server generates a control command sequence for the mobile object.

Server uses the verified route information as input and applies a conversion procedure to translate each waypoint into low-level control directives. Server calculates desired speed and altitude for each segment, segments the route into phases such as takeoff, cruise, and landing, and encodes these into a protocol understood by the mobile object. As output, server produces a control command sequence, formatted as a series of control messages, and transmits this sequence to the terminal associated with the mobile object via a communication channel.

### Step 10:

Terminal forwards and supervises execution of the control command sequence.

Terminal receives the control command sequence as input and decodes each control message.

Terminal applies data processing by mapping high-level commands to actuator signals through a local control unit. Terminal also monitors local sensors, such as inertial measurement units and onboard cameras, and compares measured state with commanded trajectories. As output, terminal issues actuator control signals to move the mobile object along the verified route, and generates periodic telemetry reports that summarize the current state and any deviations, sending these reports back to the server.

### Step 11:

Server performs real-time ETA prediction using telemetry and route information. Server receives successive telemetry reports and the remaining portion of the verified route as input. Server constructs a feature vector at each update, including remaining distance, current speed, trajectory curvature, wind estimates per segment, and remaining power. Server feeds this feature vector into an ETA prediction model and performs numeric computations to output a predicted remaining time. As output, server updates an estimated time of arrival value associated with the active request and logs the predictions for future model refinement.

Step 12: Server generates and transmits notification information to the user.

Server takes as input the latest estimated time of arrival, the current operation status, and notification policies. Server formats a user-readable message that may include an arrival time, explanation of delays, or confirmation of normal operation. Server performs data processing by selecting appropriate channels and scheduling criteria, then encapsulates the message into notification payloads. As output, server sends notification information, such as “Your delivery will arrive in approximately 12 minutes,” to the terminal operated by the user via messaging or push services.

### Step 13:

Terminal presents notification information and acquires optional user feedback.

Terminal receives notification information from the server as input. Terminal processes this data by updating display elements of the user interface, including text fields and map views, and may play audio alerts. Terminal optionally provides interaction elements that allow the user to acknowledge the notification, request details, or cancel the request. As output, terminal generates user feedback messages, if any, and transmits these feedback messages to the server for further processing.

### Step 14:

Terminal captures user-state data for emotion estimation.

Terminal uses a camera, a microphone, or communication interfaces as input sources to capture image information, sound information, or text information associated with the user. Terminal performs local pre-processing, such as down-sampling images, extracting voice segments, or collecting recent messages, and tags the data with user identifiers and timestamps. As output, terminal produces user-state data packets that represent the user's facial expressions, voice tone, or text content and sends these packets securely to the server.

### Step 15:

Server estimates the emotion of the user from user-state data.

Server receives user-state data packets as input and routes them to an emotion estimation module. Server performs data processing by extracting features such as facial landmark coordinates, acoustic spectra, or linguistic sentiment scores. Server feeds these features into an emotion estimation model, which outputs numeric scores for predefined emotion categories. As output, server selects an emotion label with the highest score, such as joy or neutral, and records the estimated emotion in association with the active request and the user.

### Step 16:

Server adjusts transport priority and route parameters based on estimated emotion.

Server uses the estimated emotion, current priority level, and system policies as input. Server applies a priority mapping function that computes an adjusted priority value according to the emotion category and current operational load. Server also evaluates whether route parameters, such as allowed detours or notification frequency, should be modified. As output, server updates internal scheduling queues and route metadata, potentially moving the user's request higher or lower in the execution order and adjusting related timing parameters.

### Step 17:

Server evaluates safety conditions and, if necessary, generates a retreat route using the generative AI model.

Server receives environmental sensing data and obstacle detection data, along with the current route and position, as input. Server applies pre-defined safety thresholds to determine whether conditions exceed acceptable limits. If a violation is detected, server composes a retreat-specific prompt sentence that encodes the current position, hazardous factors, and available safe retreat points. Server transmits this prompt sentence to the generative AI model and receives a retreat route candidate as output. Server then processes the candidate, verifies it with the route search algorithm, and updates route information to reflect a safe retreat path.

### Step 18:

Server generates a retreat control command sequence and coordinates safe termination.

Server uses the verified retreat route as input and converts waypoints into a specialized control command sequence for retreat. Server encodes commands that gradually direct the mobile object toward a designated safe retreat point while satisfying descent and speed limits. As output, server sends the retreat control command sequence to the terminal, marks the request status as delayed or interrupted due to safety conditions, and generates corresponding notification information for the user, thereby closing the control loop for safe handling of hazardous situations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

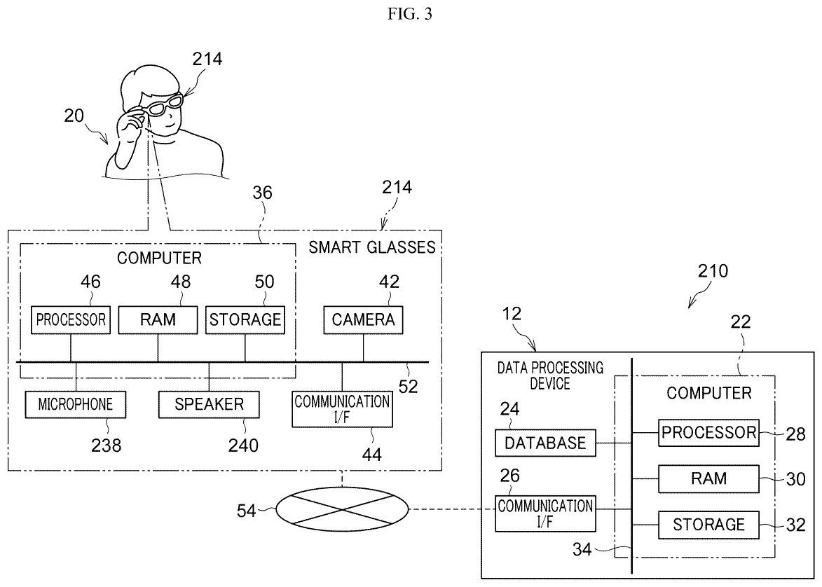

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

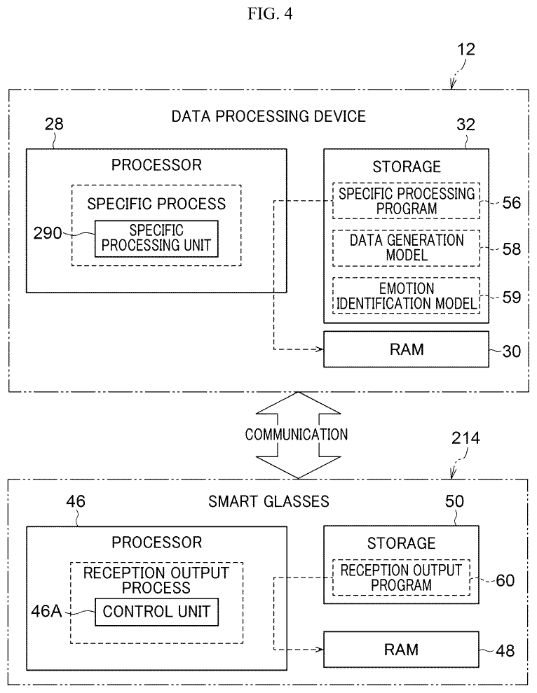

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

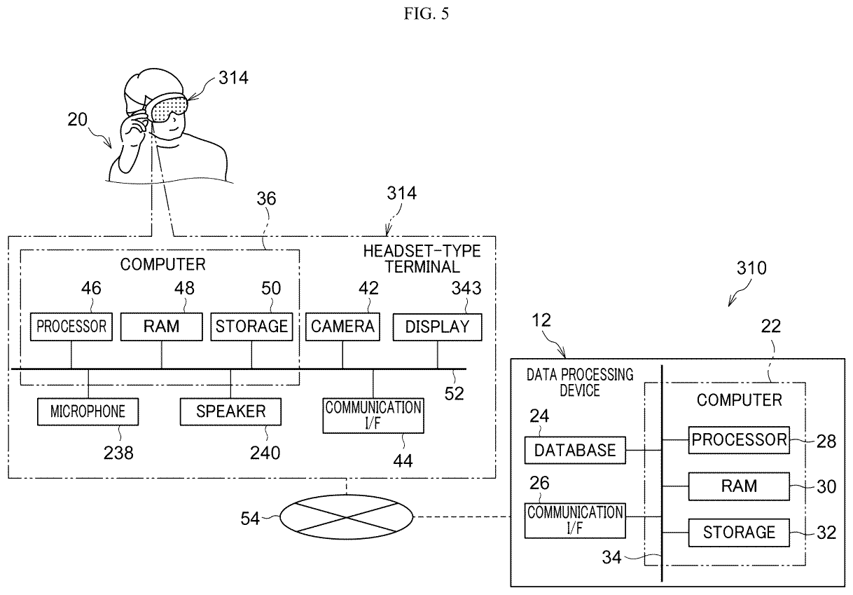

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

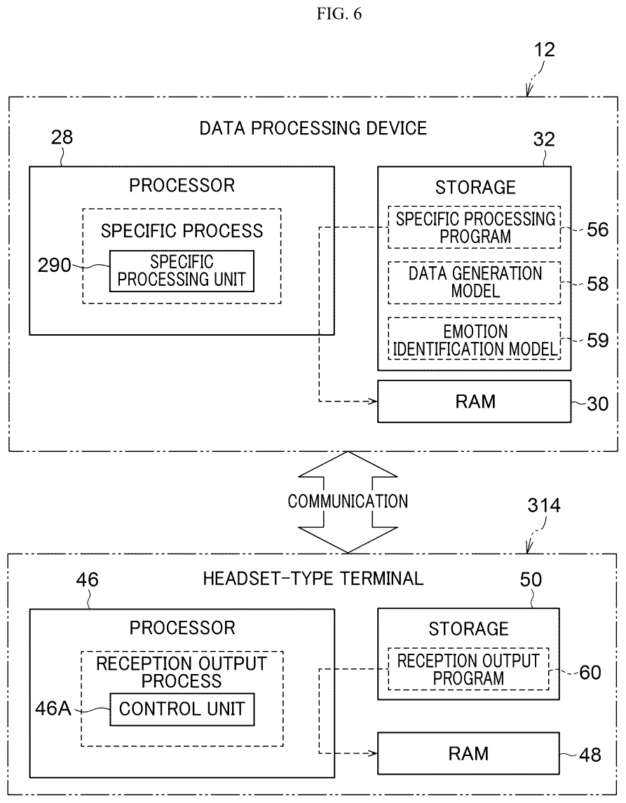

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

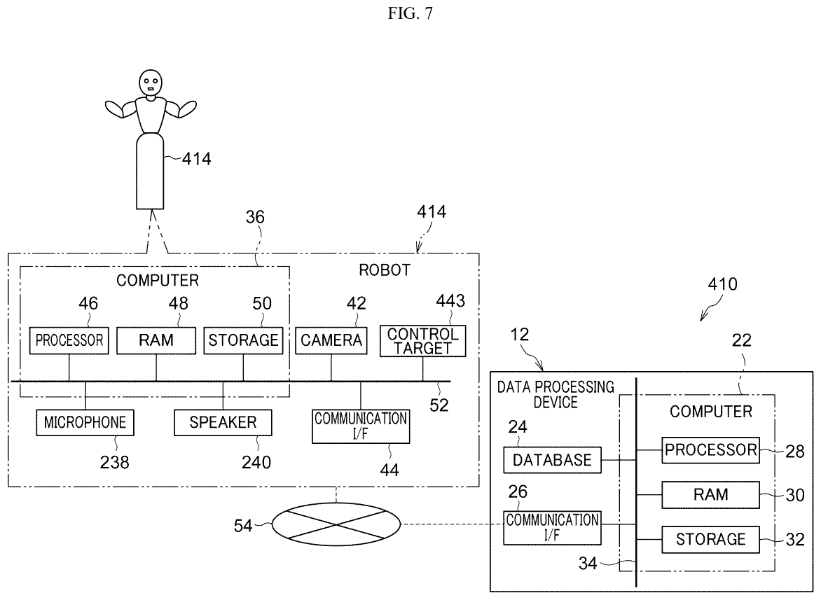

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

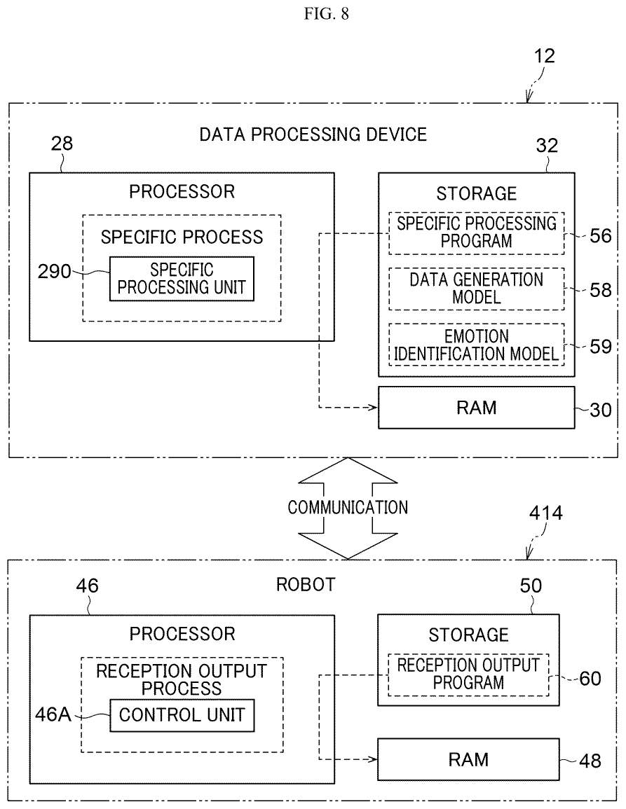

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

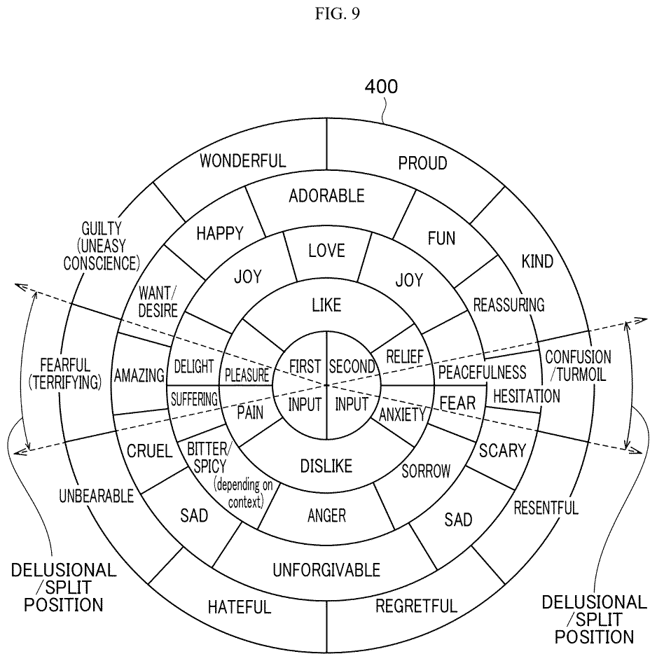

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

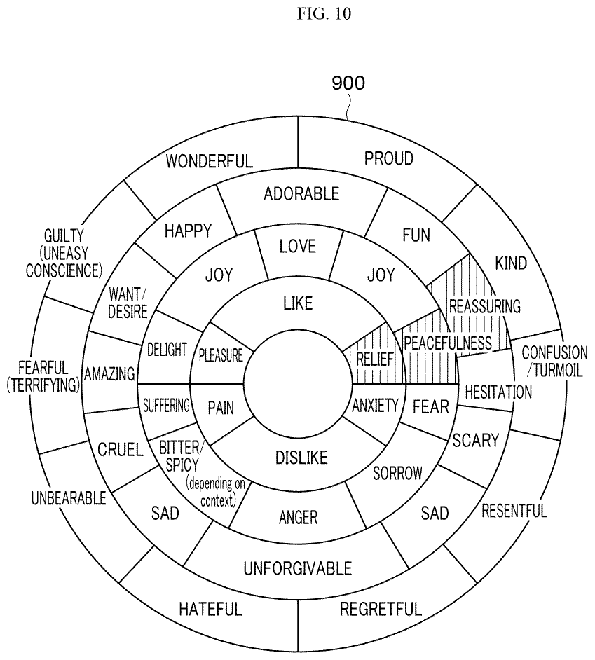

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire position information indicating a current position of a mobile body from a position detection device,
acquire map information including road information, obstacle information, and traffic information from a geographic information storage device via a communication network, generate environment state data by integrating the position information and the map information based on destination information and constraint condition information received from a user terminal,
generate a prompt sentence for input to a generative AI model based on the environment state data, input the prompt sentence to the generative AI model, and thereby cause the generative AI model to generate route information including a plurality of route points and a recommended movement condition corresponding to each of the route points for movement of the mobile body to a destination,
verify safety and feasibility of each of the route points included in the route information based on the map information and no-go-zone information, and correct the route information, calculate an estimated arrival time of the mobile body based on the corrected route information,
transmit the corrected route information and the estimated arrival time to the mobile body and the user terminal, and
acquire position information and state information periodically transmitted from the mobile body, calculate a deviation between the acquired information and the corrected route information, and generate, based on the deviation, a prompt sentence for re-input to the generative AI model so as to dynamically update the route information.

### (Supplementary 2)

The system according to supplementary 1,
wherein the processor is configured to
analyze an instruction sentence expressed in natural language and received from the user terminal, generate a prompt sentence for input to the generative AI model based on an analysis result, and plan and replan a movement route of the mobile body by using the prompt sentence.

### (Supplementary 3)

The system according to supplementary 1,
wherein the processor is configured to
analyze obstacle information and weather information acquired from an environment detection device mounted on the mobile body and from an external information providing device, determine a degree of risk based on an analysis result, and, when the degree of risk exceeds a predetermined threshold, input to the generative AI model a prompt sentence instructing generation of a safe evacuation route starting from a current position of the mobile body, generate the evacuation route by using the generative AI model, and transmit the generated evacuation route to the mobile body.

### Application Example 1

### (Supplementary 1)

A system comprising a processor,
wherein the processor is configured to
acquire current position information of a transport body by using a position detection device, acquire geographic information for route calculation from a geographic information storage device via a communication network,
receive delivery request information and destination information from a user terminal and, based on the delivery request information and the destination information, select the transport body and generate route calculation input data associating current position information of the transport body with the destination information,
generate, based on the route calculation input data and the geographic information, a prompt sentence for causing a generative information processing model to calculate a transport route of the transport body and an estimated arrival time, input the prompt sentence to the generative information processing model, and obtain route information of the transport route and arrival prediction time information as an output of the generative information processing model,
generate command information for instructing autonomous transport to the transport body based on the route information of the transport route and transmit the command information to the transport body,
acquire current position information and state information that are transmitted at predetermined intervals from the transport body, collate the current position information and the state information with the route information of the transport route, update the arrival prediction time information based on a result of the collation, and generate transport status information including updated arrival prediction time information,
transmit the transport status information to the user terminal and cause the user terminal to display at least a current position of the transport body and the arrival prediction time information, and
determine, based on obstacle information and environment information transmitted from the transport body, whether continuation of transport is possible, and when it is determined that continuation of transport is not possible, generate a prompt sentence to be input to the generative information processing model, obtain evacuation route information including a safe waiting position from the generative information processing model, and perform a waiting instruction to the transport body based on the evacuation route information.

### (Supplementary 2)

The system according to supplementary 1,
wherein the processor is configured to dynamically generate the prompt sentence to be input to the generative information processing model in accordance with setting information relating to operation policies including at least a time reduction requirement for the transport route, a safety priority level, and a restriction for avoiding non-passable areas, and to reflect processing procedure information or configuration information for route calculation, output from the generative information processing model in response to the prompt sentence, in a calculation process of the transport route and a calculation process of the evacuation route.

### (Supplementary 3)

The system according to supplementary 1,
wherein the processor is configured to acquire operation policy setting information input from a management terminal, and, based on the operation policy setting information, change contents of the prompt sentence to be input to the generative information processing model so as to update optimization conditions for the transport route and generation conditions for an evacuation route.

### Example 2

### (Supplementary 1)

A system comprising a processor,
wherein the processor is configured to
acquire a current position of a moving body by using a position acquisition device, obtain geographic information and environmental information from a storage device via an information communication network,
generate a prompt sentence for instructing a generative AI model to calculate an optimal route based on the geographic information and the environmental information, and input the prompt sentence together with the geographic information and the environmental information to the generative AI model,
acquire route information output from the generative AI model, the route information including a plurality of route points and movement conditions, and convert the route information into a sequence of control commands for the moving body,
transmit the sequence of control commands to the moving body by using a wireless communication unit,
generate an additional prompt sentence for instructing the generative AI model to perform recalculation of a route or calculation of a retreat route based on position information and state information acquired from the moving body and based on the environmental information, and input the additional prompt sentence to the generative AI model, and calculate an estimated arrival time based on the position information of the moving body and the route information, and transmit notification information to an information terminal.

### (Supplementary 2)

The system according to supplementary 1,
wherein the processor is configured to
receive delivery request information from the information terminal and include destination information and package information contained in the delivery request information in input data to be supplied to the generative AI model.

### (Supplementary 3)

The system according to supplementary 1,
wherein the processor is configured to
analyze sensor information acquired from the moving body and the environmental information, determine continuation of movement or retreat of the moving body in accordance with an obstacle or a weather condition, and generate a safe retreat point and a retreat route based on an output of the generative AI model.

### Application Example 2

### (Supplementary 1)

A system comprising a processor,
wherein the processor is configured to
acquire a current position of a mobile object or a user by using a position acquisition device, obtain geographic information and route constraint information necessary for route calculation from a geographic information storage apparatus via a communication network, generate operation status information including weather information, traffic information, remaining power information, and obstacle information based on data acquired from an environmental sensing device and the mobile object,
generate a prompt sentence to be input to a generative information processing model on the basis of the operation status information and the geographic information, the prompt sentence instructing calculation of a route candidate and a route control policy to a destination, obtain the route candidate output from the generative information processing model, verify or correct the route candidate by using a route search algorithm, and generate route information that satisfies safety and feasibility,
generate a control command sequence for an unmanned mobile object or a vehicle on the basis of the route information, and transmit the control command sequence to the unmanned mobile object or the vehicle to cause the unmanned mobile object or the vehicle to perform autonomous movement or autonomous transport,
acquire position information and operation information transmitted from the unmanned mobile object or the vehicle, and predict an estimated time of arrival on the basis of operation information including travel speed, remaining distance, and wind speed information, generate notification information according to the estimated time of arrival and an operation status, and transmit the notification information to a user information processing apparatus, and
estimate an emotion of the user from information indicating an emotional state of the user by using an emotion estimation model, and generate control information for changing at least one of the route information and a transport priority in accordance with the emotion.

### (Supplementary 2)

The system according to supplementary 1,
wherein the processor is configured to
acquire, as the information indicating the emotional state of the user, at least one of image information, sound information, communication text information, and posting information to an information dissemination service, generate a prompt sentence for the emotion estimation model or the generative information processing model, estimate the emotion based on a response of the model to the prompt sentence, and perform control to change at least one of a notification frequency of the estimated time of arrival and a priority of the autonomous movement or the autonomous transport in accordance with the estimated emotion.

### (Supplementary 3)

The system according to supplementary 1,
wherein the processor is configured to
analyze data from the environmental sensing device and an obstacle detection device, determine that a predetermined safety condition is not satisfied, generate a prompt sentence for the generative information processing model to obtain a retreat route candidate to a safe retreat point, obtain the retreat route candidate from the generative information processing model, verify the retreat route candidate by using the route search algorithm, generate a retreat control command sequence based on a verified retreat route, and control the unmanned mobile object or the vehicle to retreat along the retreat route.

What is claimed is:

1. A system comprising:
circuitry configured to:
receive, via a communication interface coupled to a packet-switched network, position information indicating a current position of a mobile body from a position detection device, and acquire map information including road information, obstacle information, and traffic information from a geographic information storage device via the communication interface;
generate environment state data by integrating the position information, the map information, destination information, and constraint condition information received from a terminal device, and generate a prompt sentence based on the environment state data;
operate a generative neural network model using the prompt sentence to generate route information comprising a plurality of route points and a recommended movement condition corresponding to each route point for movement of the mobile body to a destination;
verify safety and feasibility of each route point in the route information against the map information and no-go-zone information stored in a storage device, correct the route information to remove or replace infeasible route points, and calculate an estimated arrival time based on the corrected route information; and
transmit the corrected route information and the estimated arrival time to the mobile body and the terminal device via the communication interface, receive position information and state information periodically from the mobile body, calculate a deviation between the received position information and the corrected route information, and generate a re-planning prompt sentence based on the deviation to operate the generative neural network model to dynamically update the route information.

2. The system according to claim 1, wherein the circuitry is configured to generate the environment state data by constructing a spatial data structure integrating the position information as a coordinate tuple, the map information as a graph of road segments and junction nodes, the destination information as a target coordinate, and the constraint condition information as a weighted preference vector, and encoding the spatial data structure as a serialized text representation for input to the generative neural network model.

3. The system according to claim 2, wherein the circuitry is configured to generate the prompt sentence by assembling segments comprising the serialized environment state data, a movement objective specification derived from the destination information and constraint condition information, and a route output format specification defining required fields for route points, movement conditions, and distance values.

4. The system according to claim 3, wherein the circuitry is configured to operate the generative neural network model by transmitting the prompt sentence to a transformer-based generative neural network model, configuring decoding parameters to enforce route point format constraints, and parsing the generated output tokens to extract structured route point records comprising coordinate values and movement condition codes.

5. The system according to claim 4, wherein the circuitry is configured to verify the safety and feasibility of each route point by performing a spatial proximity query against the no-go-zone information stored in the storage device, checking road network connectivity between consecutive route points using the map information graph, and applying a traversability condition check for each movement condition code against road attribute data.

6. The system according to claim 1, wherein the circuitry is configured to calculate the estimated arrival time by applying a travel time model that computes segment traversal times as a function of segment length, road type, and traffic information values, summing the segment traversal times along the corrected route, and adjusting the sum using a temporal delay factor derived from current traffic information.

7. The system according to claim 6, wherein the circuitry is configured to update the estimated arrival time by monitoring position information received from the mobile body, computing a remaining route distance from the current position to the destination along the corrected route information, and recomputing the estimated arrival time using the travel time model applied to remaining route segments.

8. The system according to claim 1, wherein the circuitry is configured to calculate the deviation by computing a perpendicular distance from a current position coordinate to the nearest route segment in the corrected route information, and computing a heading deviation as a difference between a current heading derived from successive position information readings and a target heading for the nearest route segment.

9. The system according to claim 8, wherein the circuitry is configured to generate the re-planning prompt sentence by incorporating the current position, the heading deviation, the remaining destination distance, the updated map information, and a deviation correction instruction into a structured prompt format, and transmit the re-planning prompt sentence to the generative neural network model when the perpendicular distance or heading deviation exceeds a deviation threshold.

10. The system according to claim 9, wherein the circuitry is configured to apply the safety and feasibility verification procedure to the dynamically updated route information generated by the generative neural network model, correct infeasible route points in the updated route information, and transmit the corrected updated route information and an updated estimated arrival time to the mobile body and the terminal device via the communication interface.

11. The system according to claim 1, wherein the circuitry is configured to receive sensor data from one or more sensors of the mobile body via the communication interface, apply a hazard detection procedure to the sensor data to detect obstacle conditions or environmental hazard conditions, and when a hazard condition is detected, generate an evacuation prompt sentence incorporating the sensor data, current position, and hazard classification.

12. The system according to claim 11, wherein the circuitry is configured to operate the generative neural network model using the evacuation prompt sentence to generate evacuation route information comprising evacuation route points and urgency-conditioned movement conditions, verify the evacuation route points against the no-go-zone information, and transmit the verified evacuation route information to the mobile body and the terminal device via the communication interface with an elevated priority flag.

13. The system according to claim 11, wherein the circuitry is configured to apply the hazard detection procedure by extracting feature vectors from the sensor data using signal processing operations, applying a trained hazard classifier to the feature vectors to compute hazard probability scores for a set of hazard categories, and classifying a hazard condition when a hazard probability score exceeds a hazard threshold.

14. The system according to claim 1, wherein the circuitry is configured to update the map information by receiving differential map update records from the geographic information storage device via the communication interface, applying the differential map update records to the stored map information graph by inserting, modifying, or removing road segment records and junction node records, and using the updated map information graph in subsequent route generation and verification operations.

15. The system according to claim 1, wherein the circuitry is configured to store the route information, the corrected route information, the deviation records, and the re-planning prompt sentences as route session records in the storage device indexed by mobile body identifier, and compute a route quality metric for each session by applying a scoring function to accumulated deviation records.

16. The system according to claim 15, wherein the circuitry is configured to use accumulated route session records as training examples for updating parameters of the generative neural network model, assigning labels to route sessions based on whether the mobile body reached the destination without exceeding a deviation threshold, and applying a policy gradient optimization procedure to update model parameters using the labeled route session records.

17. The system according to claim 1, wherein the circuitry is configured to coordinate route information transmission to a plurality of mobile bodies by maintaining separate corrected route information and estimated arrival time records for each mobile body in the storage device, processing periodic position information and state information from each mobile body independently, and generating individual re-planning prompt sentences for each mobile body based on respective deviation calculations.

18. A system comprising:
circuitry configured to:
receive, via a communication interface coupled to a packet-switched network, position information from a position detection device and map information including road information, obstacle information, and traffic information from a geographic information storage device;
generate environment state data by integrating position information, map information, destination information, and constraint condition information as a spatial data structure encoded as a serialized text representation, and generate a prompt sentence assembling the environment state data, a movement objective specification, and a route output format specification;
operate a transformer-based generative neural network model using the prompt sentence to generate route information comprising structured route point records with coordinate values and movement condition codes, verify each route point against no-go-zone information and road network connectivity, and correct infeasible route points;
calculate an estimated arrival time by applying a travel time model to corrected route segments using road type and traffic information values, and transmit corrected route information and estimated arrival time to the mobile body and the terminal device via the communication interface;
receive periodic position information and state information from the mobile body, compute perpendicular distance and heading deviation, and generate a re-planning prompt sentence when deviations exceed thresholds to dynamically update route information using the generative neural network model; and
receive sensor data from sensors of the mobile body, apply a hazard detection procedure using a trained hazard classifier to detect hazard conditions, and generate evacuation route information with urgency-conditioned movement conditions for transmission to the mobile body and terminal device.

19. The system according to claim 18, wherein the circuitry is configured to store route session records in a storage device indexed by mobile body identifier, compute route quality metrics from accumulated deviation records, and use labeled route session records as training examples for updating generative neural network model parameters via a policy gradient optimization procedure.

20. A method comprising:
receiving, via a communication interface coupled to a packet-switched network, position information indicating a current position of a mobile body from a position detection device, and acquiring map information including road information, obstacle information, and traffic information from a geographic information storage device via the communication interface;
generating environment state data by integrating the position information, the map information, destination information, and constraint condition information received from a terminal device, and generating a prompt sentence based on the environment state data;
operating a generative neural network model using the prompt sentence to generate route information comprising a plurality of route points and a recommended movement condition corresponding to each route point for movement of the mobile body to a destination;
verifying safety and feasibility of each route point in the route information against the map information and no-go-zone information stored in a storage device, correcting the route information to remove or replace infeasible route points, and calculating an estimated arrival time based on the corrected route information; and
transmitting the corrected route information and the estimated arrival time to the mobile body and the terminal device via the communication interface, receiving position information and state information periodically from the mobile body, calculating a deviation between the received position information and the corrected route information, and generating a re-planning prompt sentence based on the deviation to operate the generative neural network model to dynamically update the route information.
